(19) United States
(12) Patent Application Publication
(10) Pub. No.: US 2025/0151084 A1
(43) Pub. Date: May 8, 2025

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 19/008,675

(22) Filed: Jan. 3, 2025

Related U.S. Application Data
(63) Continuation of application No. PCT/CN2023/106501, filed on Jul. 10, 2023.

(30) Foreign Application Priority Data
Jul. 20, 2022 (CN) 202210857518.1

(51) Int. Cl. H04W 72/232; H04L 5/00; H04W 72/1268

(52) U.S. Cl. CPC H04W 72/232; H04L 5/0057; H04W 72/1268

(57) ABSTRACT

A first node receives a first message set and a first DCI; performs a measurement on a first RS resource group; transmits a first CSI on a PUSCH of a first cell. The first message set comprises a first message, and the first DCI comprises a first field and a second field; the first DCI is used to schedule PUSCHs on at least K cells, K being a positive integer greater than 1; the first cell is one of the K cells; the first field of the first DCI is used to trigger the first CSI; the second field of the first DCI is used to determine the first cell; the measurement performed on the first RS resource group is used to calculate the first CSI, and the first message is used to indicate the first RS resource group.

### CROSS REFERENCE TO RELATED APPLICATIONS

This application is the continuation of the international patent application No. PCT/CN2023/106501, filed on Jul. 10,2023, and claims the priority benefit of Chinese Patent Application 202210857518.1, filed on Jul. 20,2022, the full disclosure of which is incorporated herein by reference.

### BACKGROUND

### Technical Field

The present application relates to transmission methods and devices in wireless communication systems, and in particular to a scheme and device related to CSI (Channel Status Information) in a wireless communication system.

### Related Art

In traditional wireless communications, the UE (User Equipment) report may comprise at least one of a variety of auxiliary information, such as CSI, Beam Management related auxiliary information, positioning-related auxiliary information and so on. CSI comprises at least one of a CRI (CSI-RS Resource Indicator), an RI (Rank Indicator), a PMI (Precoding Matrix Indicator) or a CQI (Channel quality indicator).

The network equipment selects appropriate transmission parameters for the UE according to the UE's report, such as a camping cell, an MCS (Modulation and Coding Scheme), a TPMI (Transmitted Precoding Matrix Indicator), a TCI (Transmission Configuration Indication) and other parameters. In addition, UE's report can be used to optimize network parameters such as better cell coverage, switching base stations according to UE's location, etc.

In NR (New Radio) system, CSI report can be periodic, semi-persistent, or aperiodic. Semi-persistent CSI report needs to be activated through DCI (Downlink Control Information) or MAC CE (Medium Access Control layer Control Element), while aperiodic CSI report needs to be triggered through DCI.

### SUMMARY

In the NR (New Radio) system, one DCI scheduling Physical Uplink Shared Channels (PUSCHs)/Physical Downlink Shared Channels (PDSCHs) for multiple cells is proposed. Inventors found through researches that the existing CSI report triggering scheme may no longer be applicable in the application scenario.

To address the above problem, the present application provides a solution. It should be noted that although the original intention of the present application is to explain the transmission scenario of one DCI scheduling PUSCHs/PDMSHs for multiple cells, the present application can also be applied to the transmission scenario of one DCI scheduling a PUSCH/PDMSH for a single cell. Furthermore, adopting a unified design scheme for different scenarios (including but not limited to one DCI scheduling PUSCHs/PDSCHs for multiple cells and one DCI scheduling a PUSCH/PDSCH for a single cell) can also help reduce hardware complexity and cost. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first message set and a first DCI, the first message set comprising a first message, the first DCI comprising a first field and a second field;
performing a measurement on a first RS resource group; and
transmitting a first CSI set on a PUSCH of a first cell, the first CSI set comprising a first CSI;
herein, the first DCI is used to schedule PUSCHs on at least K cells, K being a positive integer greater than 1; the first cell is one of the K cells; the first field of the first DCI is used to trigger the first CSI; the second field of the first DCI is used to determine the first cell; the measurement performed on the first RS resource group is used to calculate the first CSI, and the first message is used to indicate the first RS resource group.

In one embodiment, the above method determines the first cell where a PUSCH bearing the first CSI set is located through the second field in the first DCI, improving the flexibility, reducing the signaling overhead, and optimizing the transmission reliability of the first CSI set.

According to one aspect of the present application, it is characterized in that the first DCI comprises K sub-fields, and the K sub-fields are respectively used for scheduling for the K cells; the second field of the first DCI comprises at least one of the K sub-fields.

According to one aspect of the present application, it is characterized in that the K sub-fields respectively indicate K MCSs, the K MCSs are respectively used for K PUSCHs, and the K PUSCHs are respectively located on the K cells.

In one embodiment, advantages of the above method include: implicitly determining the first cell where a PUSCH bearing the first CSI set is located through an MCS, saving the signaling overhead.

In one embodiment, advantages of the above method include: optimizing the transmission reliability of the first CSI set.

According to one aspect of the present application, it is characterized in that the K sub-fields are respectively used to determine K cell indices, and the K cell indices are respectively assigned to the K cells.

In one embodiment, advantages of the above method include: implicitly determining the first cell where a PUSCH bearing the first CSI set is located through the K cell indices, saving the signaling overhead.

In one embodiment, advantages of the above method include: optimizing the transmission reliability of the first CSI set.

According to one aspect of the present application, it is characterized in that the first cell is a cell indicated by a sub-field located at a target location among the K sub-fields; the target location is the default.

According to one aspect of the present application, it is characterized in that the K sub-fields are respectively used to determine priorities of K PUSCHs, and the K PUSCHs are respectively on the K cells.

In one embodiment, advantages of the above method include: implicitly determining the first cell where a PUSCH bearing the first CSI set is located through priorities of the K PUSCHs, saving the signaling overhead.

In one embodiment, advantages of the above method include: optimizing the transmission reliability of the first CSI set.

According to one aspect of the present application, it is characterized in that the second field in the first DCI indicates a first index set, the first index set comprises K cell indices, and the K cell indices are respectively assigned to the K cells.

In one embodiment, advantages of the above method include: implicitly determining the first cell where a PUSCH bearing the first CSI set is located through the K cell indices, saving the signaling overhead.

In one embodiment, advantages of the above method include: optimizing the transmission reliability of the first CSI set.

According to one aspect of the present application, it is characterized in that the first node is a UE.

According to one aspect of the present application, it is characterized in that the first node is a relay node.

The present application provides a method in a second node for wireless communications, comprising:
transmitting a first message set and a first DCI, the first message set comprising a first message, the first DCI comprising a first field and a second field;
receiving a first CSI set on a PUSCH of a first cell, the first CSI set comprising a first CSI;
herein, the first DCI is used to schedule PUSCHs on at least K cells, K being a positive integer greater than 1; the first cell is one of the K cells; the first field of the first DCI is used to trigger the first CSI; the second field of the first DCI is used to determine the first cell; a measurement performed on a first RS resource group is used to calculate the first CSI, and the first message is used to indicate the first RS resource group.

According to one aspect of the present application, it is characterized in that the first DCI comprises K sub-fields, and the K sub-fields are respectively used for scheduling for the K cells; the second field of the first DCI comprises at least one of the K sub-fields.

According to one aspect of the present application, it is characterized in that the K sub-fields respectively indicate K MCSs, the K MCSs are respectively used for K PUSCHs, and the K PUSCHs are respectively located on the K cells.

According to one aspect of the present application, it is characterized in that the K sub-fields are respectively used to determine K cell indices, and the K cell indices are respectively assigned to the K cells.

According to one aspect of the present application, it is characterized in that the first cell is a cell indicated by a sub-field located at a target location among the K sub-fields; the target location is the default.

According to one aspect of the present application, it is characterized in that the K sub-fields are respectively used to determine priorities of K PUSCHs, and the K PUSCHs are respectively on the K cells.

According to one aspect of the present application, it is characterized in that the second field in the first DCI indicates a first index set, the first index set comprises K cell indices, and the K cell indices are respectively assigned to the K cells.

According to one aspect of the present application, it is characterized in that the second node is a base station.

According to one aspect of the present application, it is characterized in that the second node is a UE.

According to one aspect of the present application, it is characterized in that the second node is a relay node.

The present application provides a first node for wireless communications, comprising:
a first receiver, receiving a first message set and a first DCI, the first message set comprising a first message, the first DCI comprising a first field and a second field; performing a measurement on a first RS resource group; and
a first transmitter, transmitting a first CSI set on a PUSCH of a first cell, the first CSI set comprising a first CSI;
herein, the first DCI is used to schedule PUSCHs on at least K cells, K being a positive integer greater than 1; the first cell is one of the K cells; the first field of the first DCI is used to trigger the first CSI; the second field of the first DCI is used to determine the first cell; the measurement performed on the first RS resource group is used to calculate the first CSI, and the first message is used to indicate the first RS resource group.

The present application provides a second node for wireless communications, comprising:
a second transmitter, transmitting a first message set and a first DCI, the first message set comprising a first message, the first DCI comprising a first field and a second field; and
a second receiver, receiving a first CSI set on a PUSCH of a first cell, the first CSI set comprising a first CSI;
herein, the first DCI is used to schedule PUSCHs on at least K cells, K being a positive integer greater than 1; the first cell is one of the K cells; the first field of the first DCI is used to trigger the first CSI; the second field of the first DCI is used to determine the first cell; a measurement performed on a first RS resource group is used to calculate the first CSI, and the first message is used to indicate the first RS resource group.

In one embodiment, the present application has the following advantages over conventional schemes:
improving the flexibility;
reducing the signaling overhead;
optimizing the reliability of CSI transmission.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first message set, a first DCI, a first RS resource set and a first CSI set according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of transmission according to one embodiment of the present application;

FIG. 6 illustrates a schematic diagram of K sub-fields according to one embodiment of the present application;

FIG. 7 illustrates a schematic diagram of K sub-fields respectively indicating K MCSs according to one embodiment of the present application;

FIG. 8 illustrates a schematic diagram of K sub-fields respectively being used to determine K cell indices according to one embodiment of the present application;

FIG. 9 illustrates a schematic diagram of K cell indices being used to determine a first cell according to one embodiment of the present application;

FIG. 10 illustrates a schematic diagram of which of K cells is configured with a PUCCH being used to determine a first cell according to one embodiment of the present application;

FIG. 11 illustrates a schematic diagram of a first cell is a cell indicated by a sub-field located at a target location in K sub-fields according to one embodiment of the present application;

FIG. 12 illustrates a schematic diagram of K sub-fields respectively being used to determine priorities of K PUSCHs according to one embodiment of the present application;

FIG. 13 illustrates a schematic diagram of a second field in a first DCI indicating a first index set according to one embodiment of the present application;

FIG. 14 illustrates a structure block diagram of a processor in a first node according to one embodiment of the present application;

FIG. 15 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

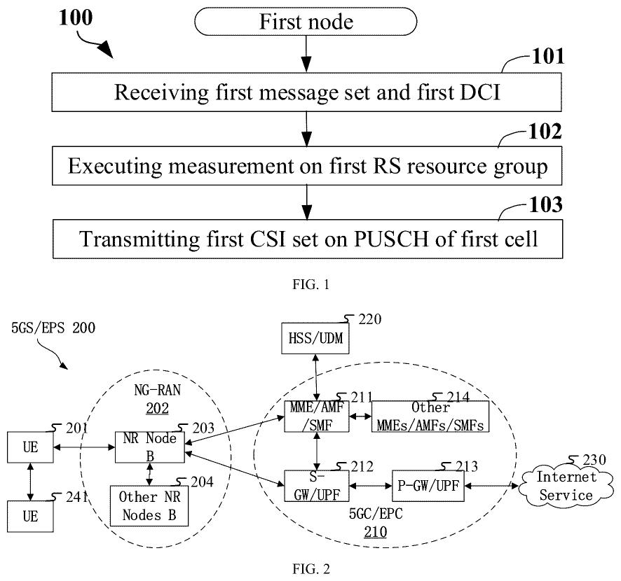

Embodiment 1 illustrates a flowchart of a first message set, a first DCI, a first RS resource set and a first CSI set according to one embodiment of the present application, as shown in FIG. 1. In 100 illustrated by FIG. 1, each box represents a step. And in particular, the order of steps in boxes does not represent a chronological order of characteristics between the steps.

In embodiment 1, the first node in the present application receives a first message set and a first DCI in step 101, the first message set comprises a first message, and the first DCI comprises a first field and a second field; executes a measurement on a first RS resource group in step 102; transmits a first CSI set on a PUSCH of the first cell in step 103, the first CSI set comprises a first CSI; herein, the first DCI is used to schedule PUSCHs on at least K cells, K being a positive integer greater than 1; the first cell is one of the K cells; the first field of the first DCI is used to trigger the first CSI; the second field of the first DCI is used to determine the first cell; the measurement performed on the first RS resource group is used to calculate the first CSI, and the first message is used to indicate the first RS resource group.

In one embodiment, the DCI refers to: Downlink Control Information.

In one embodiment, the CSI refers to: Channel State Information.

In one embodiment, the PUSCH refers to: Physical Uplink Shared Channel.

In one embodiment, the RS refers to: Reference Signal.

In one embodiment, the first message set is carried by a higher-layer signaling.

In one embodiment, the first message set is carried by a Radio Resource Control (RRC) signaling.

In one embodiment, the first message set is carried by an RRC IE (Information Element).

In one embodiment, the first information set comprises an RRC IE.

In one embodiment, the first message set comprises an RRC IE, and a name of an RRC IE comprised in the first message set includes “CSI-MeasConfig”.

In one embodiment, the first message set comprises a CSI-MeasConfig IE.

In one embodiment, the first message set comprises information in all or partial fields in a CSI-MeasConfig IE.

In one embodiment, the first message set consists of the first message.

In one embodiment, the first message set at least comprises another message other than the first message.

In one subembodiment of the above embodiment, the another message and the first message are carried by different RRC IEs respectively.

In one subembodiment of the above embodiment, the another message and the first message are respectively carried by different fields of a same RRC IE.

In one embodiment, the first message is carried by a higher-layer signaling.

In one embodiment, the first message is carried by an RRC signaling.

In one embodiment, the first message is carried by an RRC IE.

In one embodiment, the first message comprises an RRC IE.

In one embodiment, the first message comprises a CSI-MeasConfig IE.

In one embodiment, the first message comprises information in all or partial fields in a CSI-MeasConfig IE.

In one embodiment, the first message is an RRC IE, and a name of the first message includes “CSI-MeasConfig”.

In one embodiment, the first message is a CSI-MeasConfig IE.

In one embodiment, the first message is an RRC IE, and a name of the first message includes “CSI-ReportConfig”.

In one embodiment, the first message comprises information in all or partial fields in a CSI-ReportConfig IE.

In one embodiment, the first message is a CSI-ReportConfig IE.

In one embodiment, the first message comprises information in all or partial fields in a CSI-AperiodicTriggerStateList IE.

In one embodiment, the first message comprises information in all or partial fields in a CSI-ResourceConfig IE.

In one embodiment, the first field and the second field respectively comprise at least one bit.

In one embodiment, the first field comprises at least one DCI field.

In one embodiment, the first field is a DCI field.

In one embodiment, the first field comprises multiple DCI fields.

In one embodiment, the first field comprises a DCI field CSI request.

In one embodiment, the first field comprises all or partial information in a DCI field CSI request.

In one embodiment, the first field is a DCI field CSI request.

In one embodiment, the second field comprises at least one DCI field.

In one embodiment, the second field comprises multiple DCI fields.

In one embodiment, the second field is a DCI field.

In one embodiment, the second field comprises partial fields in at least one DCI field.

In one embodiment, the second field comprises partial fields in a DCI field.

In one embodiment, the second field comprises partial bits of each DCI field in multiple DCI fields.

In one embodiment, the first cell is a serving cell of the first node.

In one embodiment, the first node executes secondary cell insertion for the first cell.

In one embodiment, a sCellToAddModList or a sCellToAddModListSCG most recently received by the first node comprises the first cell.

In one embodiment, the first node is assigned an SCellIndex or ServCellIndex for the first cell.

In one embodiment, an RRC connection is established between the first node and the first cell.

In one embodiment, a C (Cell)-RNTI (Radio Network Temporary Identifier) of the first node is assigned by the first cell.

In one embodiment, a C-RNTI of the first node is assigned by a cell different from the first cell.

In one embodiment, the first cell is an SpCell (Special Cell) or SCell (Secondary Cell) of the first node.

In one embodiment, K is not greater than 8.

In one embodiment, K is not greater than 32.

In one embodiment, each of the K cells is a serving cell of the first node.

In one embodiment, the first node executes auxiliary service cell addition for each of the K cells.

In one embodiment, a sCellToAddModList or sCellToAddModListSCG most recently received by the first node comprises each of the K cells.

In one embodiment, for each of the K cells, the first node is assigned an SCellIndex or ServCellIndex for the cell.

In one embodiment, an RRC connection is established between the first node and each of the K cells.

In one embodiment, a C-RNTI of the first node is assigned by one of the K cells.

In one embodiment, a C-RNTI of the first node is assigned by a cell not belonging to the K cells.

In one embodiment, the K cells comprise an SpCell (Special Cell) of the first node.

In one embodiment, the K cells comprise an SCell (Secondary Cell) of the first node.

In one embodiment, any one of the K cells is an SpCell or SCell of the first node.

In one embodiment, for the definition of a serving cell, refer to 3GPP TS 38.331.

In one embodiment, the K cells belong to a same cell group.

In one embodiment, the K cells all belong to an MCG (Master Cell Group) or an SCG (Secondary Cell Group).

In one embodiment, the K cells belong to a same Physical Uplink Control Channel (PUCCH) group.

In one embodiment, a PUCCH group comprises a group of cells, and a PUCCH signaling of the group of cells is associated with a PUCCH of an SpCell (Special Cell) or with a PUCCH of a PUCCH SCell (Secondary Cell); a PUCCH SCell is an SCell configured with a PUCCH.

In one embodiment, a PUCCH group comprises a group of cells, and a PUCCH signaling of the group of cells is associated with a PUCCH of a same cell.

In one subembodiment of the above embodiment, a PUCCH bearing the PUCCH signaling of the group of cells is transmitted in the same cell.

In one subembodiment of the above embodiment, a PUCCH bearing the PUCCH signaling of the group of cells is configured for a PUCCH of the same cell.

In one subembodiment of the above embodiment, the same cell is a PUCCH cell of the group of cells.

In one subembodiment of the above embodiment, the same cell is an SpCell or PUCCH SCell of the group of cells.

In one subembodiment of the above embodiment, the same cell is a cell configured with a PUCCH in the group of cells.

In one subembodiment of the above embodiment, the same cell is the only cell configured with a PUCCH in the group of cells.

In one embodiment, for the definition of the PUCCH group, refer to 3GPP TS38.300 and 3GPP TS38.331.

In one embodiment, for the definition of the PUCCH SCell, refer to 3GPP TS38.300 and 3GPP TS38.331.

In one embodiment, the K cells have a same numerology.

In one embodiment, the K cells have a same subcarrier spacing configuration.

In one embodiment, K BWPs (bandwidth parts) are respectively BWPs scheduled by the first DCI for the K cells, and the K BWPs have a same numerology.

In one embodiment, K BWPs are BWPs scheduled by the first DCI for the K cells, and the K BWPs have a same subcarrier spacing configuration.

In one embodiment, the first DCI is transmitted on the first cell.

In one embodiment, the first DCI is transmitted on another cell different from the first cell.

In one subembodiment of the above embodiment, the another cell is a serving cell of the first node.

In one embodiment, the first DCI is transmitted on a second cell.

In one embodiment, frequency-domain resources occupied by the first DCI belong to the second cell.

In one embodiment, a CRC (Cyclic Redundancy Check) of the first DCI is scrambled by a first RNTI, and the first RNTI is assigned by the second cell.

In one embodiment, a cell identity of the second cell or a higher-layer parameter “pdcch-DMRS-ScramblingID” configured for the second cell is used to determine a DMRS sequence of a PDCCH (Physical Downlink Control Channel) bearing the first DCI.

In one embodiment, a cell configured by a ServingCellConfig IE to which a ControlResourceSet IE configuring a CORESET to which the first DCI belongs belongs is the second cell.

In one embodiment, a cell index indicated by a SpCellConfig or SCellConfig to which a ControlResourceSet IE configuring a CORESET to which the first DCI belongs belongs is equal to a cell index of the second cell.

In one embodiment, a CORESET to which the first DCI belongs is configured on the second cell.

In one embodiment, the second cell is a serving cell of the first node.

In one embodiment, the second cell and the first cell are a same cell.

In one embodiment, the second cell and the first cell have a same PCI (Physical Cell Identity).

In one embodiment, the second cell is a cell different from the first cell.

In one embodiment, the second cell and the first cell have different PCIs.

In one embodiment, the second cell and the K cells belong to a same cell group.

In one embodiment, the second cell and the K cells both belong to an MCG or SCG.

In one embodiment, the second cell and the K cells belong to different cell groups.

In one embodiment, the second cell and the K cells belong to a same PUCCH group.

In one embodiment, the second cell and the K cells belong to different PUCCH groups.

In one embodiment, the second cell is one of the K cells.

In one embodiment, the second cell does not belong to the K cells.

In one embodiment, the first node executes auxiliary serving cell addition for the second cell.

In one embodiment, a sCellToAddModList or a sCellToAddModListSCG most recently received by the first node comprises the second cell.

In one embodiment, the first node is assigned an SCellIndex or ServCellIndex for the second cell.

In one embodiment, an RRC connection is established between the first node and the second cell.

In one embodiment, a C-RNTI of the first node is assigned by the second cell.

In one embodiment, a C-RNTI of the first node is assigned by a cell different from the second cell.

In one embodiment, the second cell is an SpCell (Special Cell) or SCell (Secondary Cell) of the first node.

In one embodiment, the first DCI is transmitted in a first BWP of the second cell, and the first BWP and the K BWPs have a same subcarrier spacing configuration.

In one embodiment, the first DCI is transmitted in a first BWP of the second cell, and the first BWP and the K BWPs have different subcarrier spacing configurations.

In one embodiment, the measurement executed on the first RS resource group includes: a measurement executed on each RS resource in the first RS resource group.

In one embodiment, the measurement executed on the first RS resource group includes: a measurement executed on at least one RS resource in the first RS resource group.

In one embodiment, the measurement executed on the first RS resource group includes: a measurement for an RS signal transmitted in each RS resource in the first RS resource group.

In one embodiment, the measurement executed on the first RS resource group includes: a measurement for an RS signal transmitted in at least one RS resource in the first RS resource group.

In one embodiment, the measurement executed on the first RS resource group includes a channel measurement.

In one embodiment, the measurement executed on the first RS resource group is a channel measurement.

In one embodiment, the measurement executed on the first RS resource group includes an interference measurement.

In one embodiment, the first node obtains a channel measurement for calculating the first CSI based on the measurement executed on the first RS resource group.

In one embodiment, the first node obtains an interference measurement for calculating the first CSI based on the measurement executed on the first RS resource group.

In one embodiment, the first RS resource group comprises at least one RS resource.

In one embodiment, the first RS resource group only comprises one RS resource.

In one embodiment, the first RS resource group comprises multiple RS resources.

In one embodiment, the first RS resource group comprises at least one CSI-RS (Channel State Information Reference Signal) resource set.

In one embodiment, the first RS resource group is a CSI-RS resource set.

In one embodiment, the first RS resource group is identified by an NZP-CSI-RS-ResourceSetId.

In one embodiment, the first RS resource group is identified by a CSI-SSB-ResourceSetId.

In one embodiment, the first RS resource group comprises at least one CSI-IM (Channel State Information Interface Measurement) resource set.

In one embodiment, the first RS resource group is a CSI-IM resource set.

In one embodiment, the first RS resource group comprises at least one CSI-RS resource set and at least one CSI-IM resource set.

In one embodiment, there exists one RS resource in the first RS resource group being a CSI-RS resource.

In one embodiment, there exists one RS resource in the first RS resource group being an SS (Synchronization Signal)/PBCH (Physical Crop Channel) Block resource.

In one embodiment, there exists one RS resource in the first RS resource group being a CSI-IM resource.

In one embodiment, any RS resource in the first RS resource group is a CSI-RS resource, an SS/PBCH Block resource, or a CSI-IM resource.

In one embodiment, any RS resource in the first RS resource group is a CSI-RS resource or an SS/PBCH block resource.

In one embodiment, any RS resource in the first RS resource group is a downlink RS resource.

In one embodiment, any RS resource in the first RS resource group comprises at least one RS port.

In one embodiment, the RS port comprises a CSI-RS port.

In one embodiment, the RS port comprises an antenna port.

In one embodiment, a CSI-RS resource set is identified by an NZP-CSI-RS-ResourceSetId.

In one embodiment, a CSI-RS resource set is configured by an NZP-CSI-RS-ResourceSet IE.

In one embodiment, a CSI-RS resource set comprises at least one CSI-RS resource.

In one embodiment, a CSI-RS resource is identified by an NZP-CSI-RS-ResourceId.

In one embodiment, a CSI-RS resource is configured by an NZP-CSI-RS-Resource IE.

In one embodiment, a CSI-IM resource set is identified by a CSI-IM-ResourceSetId.

In one embodiment, a CSI-IM resource set is configured by a CSI-IM-ResourceSet IE.

In one embodiment, a CSI-IM resource set comprises at least one CSI-IM resource.

In one embodiment, a CSI-IM resource is identified by a CSI-IM-ResourceId.

In one embodiment, a CSI-IM resource is configured by a CSI-IM-Resource IE.

In one embodiment, an SS/PBCH Block resource is identified by an SSB-Index.

In one embodiment, the first message is used to configure a CSI-ReportConfig corresponding to the first CSI.

In one embodiment, the first message comprises a CSI-ReportConfig IE corresponding to the first CSI.

In one embodiment, the first message is used to indicate: RS resources used for a channel measurement of a CSI-ReportConfig corresponding to the first CSI comprise the first RS resource group.

In one embodiment, the first message comprises a CSI-ResourceConfig IE for configuring the first RS resource group.

In one embodiment, the first message comprises a CSI-MeasConfig IE to which a CSI-ReportConfig corresponding to the first CSI belongs.

In one embodiment, the first RS resource group is on the first cell.

In one embodiment, the second field of the first DCI is used to determine a cell where the first RS resource group is located.

In one embodiment, the first RS resource group is on another cell different from the first cell.

In one embodiment, the first DCI is transmitted on a second cell, and the first RS resource group is transmitted on the second cell.

In one embodiment, the first RS resource group is located on a target cell, and a CSI-ReportConfig corresponding to the first CSI is used to determine the target cell.

In one embodiment, the first RS resource group is on a target cell; when a CSI-ReportConfig corresponding to the first CSI comprises a “carrier” field, the target cell is a cell indicated by the “carrier” field; when a CSI-ReportConfig corresponding to the first CSI does not comprise “carrier” field, the target cell is a given cell, and the CSI-ReportConfig corresponding to the first CSI is on the given cell.

In one embodiment, the meaning of an RS resource group being on a cell includes: the RS resource group is configured for the cell.

In one embodiment, the meaning of an RS resource group being on a cell includes: the RS resource group is configured on the cell.

In one embodiment, the meaning of an RS resource group being on a cell includes: frequency-domain resources occupied by the RS resource group belong to the cell.

In one embodiment, the meaning of an RS resource group being on a cell includes: an RS transmitted in the RS resource group is transmitted in the cell.

In one embodiment, the meaning of an RS resource group being on a cell includes: a cell configured by a ServingCellConfig IE to which an IE configuring the RS resource group belongs is the cell.

In one embodiment, the meaning of an RS resource group being on a cell includes: a cell index indicated by a SpCellConfig or SCellConfig to which an IE configuring the RS resource group belongs is equal to a cell index of the cell.

In one embodiment, the IE for configuring an RS resource group comprises at least one IE.

In one embodiment, the IE for configuring an RS resource group comprises at least one of a CSI-ResourceConfig IE, an NZP-CSI-RS-ResourceSet IE, a CSI-SSB-ResourceSet IE, a CSI-IM-ResourceSet IE or a CSI-AperiodicTriggerStateList IE.

In one embodiment, the cell index comprises at least one of ServCellIndex or SCellIndex; the cell index indicated by a SpCellConfig is a ServCellIndex; the cell index indicated by a SCellConfig is a SCellIndex.

In one embodiment, all RS resources in the first RS resource group are on a same cell.

In one embodiment, all RS resources in the first RS resource group are on the first cell.

In one embodiment, the first DCI is transmitted on a second cell, and all RS resources in the first RS resource group are transmitted on the second cell.

In one embodiment, there exist two RS resources in the first RS resource group respectively being on different cells.

In one embodiment, there exist two RS resources in the first RS resource group respectively being configured in different cells.

In one embodiment, there exist frequency-domain resources occupied by two RS resources in the first RS resource group respectively belonging to different cells.

In one embodiment, there exist two RS resources in the first RS resource group, and IEs for configuring the two RS resources respectively belong to two different ServingCellConfig IEs.

In one subembodiment of the above embodiment, the two different ServingCellConfig IEs are respectively used to configure two different cells.

In one embodiment, there exist two RS resources in the first RS resource group, and cell indices indicated by a SpCellConfig or SCellConfig to which IEs for configuring the two RS resources belong are not equal.

In one embodiment, there exist one RS resource in the first RS resource group being on the first cell, and there exists another RS resource in the first RS resource group being on another cell different from the first cell.

In one embodiment, the first DCI is transmitted on a second cell; there exists one RS resource in the first RS resource group being on the second cell, and there exists another RS resource in the first RS resource group being on another cell different from the second cell.

In one embodiment, any resource group in the first RS resource group is on one of the K cells.

In one embodiment, there exists one resource group in the first RS resource group being on a cell not belonging to the K cells.

In one embodiment, the meaning of an RS resource being on a cell includes: the RS resource being configured in the cell.

In one embodiment, the meaning of an RS resource being on a cell includes: frequency-domain resources occupied by the RS resource belong to the cell.

In one embodiment, the meaning of an RS resource being on a cell includes: a cell configured by a ServingCellConfig IE to which an IE configuring the RS resource group belongs is the cell.

In one embodiment, the meaning of an RS resource being on a cell includes: a cell index indicated by a SpCellConfig to which an IE configuring the RS resource belongs or a SCellConfig is equal to a cell index of the cell.

In one embodiment, the IE for configuring an RS resource comprises indicating an IE.

In one embodiment, the IE for configuring an RS resource comprises at least one of an NZP-CSI-RS-Resource IE or a CSI-IM Resource IE.

In one embodiment, at least one RS resource in the first RS resource group is a CSI-RS resource, and an IE for configuring the first RS resource group comprises at least one of an NZP-CSI-RS-ResourceSet IE or a CSI ResourceConfig IE.

In one embodiment, at least one RS resource in the first RS resource group is a CSI-IM resource, and an IE for configuring the first RS resource group comprises at least one of a CSI-IM-ResourceSet IE or a CSI-ResourceConfig IE.

In one embodiment, at least one RS resource in the first RS resource group is an SS/PBCH block resource, and an IE for configuring the first RS resource group comprises at least one of a CSI-SSB-ResourceSete IE or a CSI-ResourceConfig IE.

In one embodiment, for any given RS resource in the first RS resource group, if the given RS resource is a CSI-RS resource, an IE configuring the given RS resource comprises an NZP-CSI-RS-Resource IE.

In one embodiment, for any given RS resource in the first RS resource group, if the given RS resource is a CSI-IM resource, an IE for configuring the given RS resource comprises a CSI-IM-Resource IE.

In one embodiment, the first CSI set is only transmitted on the PUSCH of the first cell in the K cells.

In one embodiment, the first CSI set is transmitted on a PUSCH scheduled by the first DCI on only the first cell among the K cells.

In one embodiment, the first field of the first DCI is used to trigger a report of the first CSI.

In one embodiment, the first field of the first DCI indicates a trigger state of the first CSI.

In one embodiment, the first field of the first DCI indicates a trigger state of a CSI-ReportConfig corresponding to the first CSI.

In one embodiment, a trigger state of a CSI-ReportConfig corresponding to the first CSI is configured by an RRC signaling.

In one embodiment, a trigger state of a CSI-ReportConfig corresponding to the first CSI is configured by a CSI-AperiodicTriggerStateList IE.

In one embodiment, the first field of the first DCI is used to trigger a report of the first CSI set.

In one embodiment, the first field of the first DCI is used to trigger a report of each CSI in the first CSI set.

In one embodiment, trigger states of all CSIs in the first CSI set are the same.

In one embodiment, a trigger state of a CSI-ReportConfig corresponding to each CSI in the first CSI set is the same.

In one embodiment, the first CSI set comprises at least one CSI.

In one embodiment, any CSI in the first CSI set comprises at least one of Channel Quality Indicator (CQI), PMI (Precoding Matrix Indicator), CRI (CSI-RS Resource Indicator), LI (Layer Indicator), an RI (Rank Indicator), SSBRI (SS/PBCH Block Resource Indicator), L1-RSRP (Layer 1 Reference Signal received power), or L1-SINR (Layer 1-Signal-to-Interference and Noise Ratio).

In one embodiment, any CSI in the first CSI set comprises at least one of CQI, PMI, CRI, LI, RI, SSBRI, L1-RSRP, L1-SINR, capability index, or capability set index.

In one embodiment, the first CSI set comprises an RI.

In one embodiment, the first CSI set comprises a CRI.

In one embodiment, the first CSI set comprises a CQI.

In one embodiment, the first CSI set comprises a PMI.

In one embodiment, the first CSI comprises at least one of CQI, PMI, CRI, LI, RI, SSBRI, L1-RSRP, L1-SINR, capability index, or capability set index.

In one embodiment, the first CSI comprises RI.

In one embodiment, the first CSI comprises CRI.

In one embodiment, the first CSI comprises CQI.

In one embodiment, the first CSI comprises a wideband CQI.

In one embodiment, the first CSI comprises at least one sub-band CQI.

In one embodiment, the first CSI comprises PMI.

In one embodiment, the first DCI is transmitted on a second cell, and a CSI-ReportConfig corresponding to the first CSI is transmitted on the second cell.

In one embodiment, a CSI-ReportConfig corresponding to the first CSI is on the first cell.

In one embodiment, the meaning of a CSI-ReportConfig being on a cell includes: the CSI ReportConfig is configured on the cell.

In one embodiment, the meaning of a CSI-ReportConfig being on a cell includes: the CSI-ReportConfig is configured to the cell.

In one embodiment, the meaning of a CSI-ReportConfig being on a cell includes: a cell configured by a ServingCellConfig IE to which the CSI ReportConfig belongs is the cell.

In one embodiment, the meaning of a CSI-ReportConfig being on a cell includes: a cell index indicated by a SpCellConfig or SCellConfig to which the CSI ReportConfig belongs is equal to a cell index of the cell.

In one embodiment, the first CSI set consists of the first CSI.

In one embodiment, in addition to the first CSI, the first CSI set at least also comprises a CSI.

In one embodiment, any two CSIs in the first CSI set correspond to different CSI-ReportConfigs.

In one embodiment, there exist two CSIs in the first CSI set corresponding to a same CSI-ReportConfig.

In one embodiment, CSI-ReportConfigs corresponding to any two CSIs in the first CSI set are identified by different CSI-ReportConfigIds.

In one embodiment, there exist CSI-ReportConfigs corresponding to two CSIs in the first CSI set being identified by a same CSI-ReportConfigId.

In one embodiment, a CSI-ReportConfig corresponding to any CSI in the first CSI set is on the first cell.

In one embodiment, the first DCI is transmitted in a second cell, and a CSI-ReportConfig corresponding to any CSI in the first CSI set is on the second cell.

In one embodiment, there exist CSI-ReportConfigs corresponding to two CSIs in the first CSI set being respectively on different cells.

In one embodiment, the first CSI set occupies an RE (Resource Element) assigned to the PUSCH of the first cell.

In one embodiment, the first CSI set adopts a modulation method same as the PUSCH of the first cell.

Generally speaking, how to calculate CSI is determined by the hardware equipment manufacturer. The following takes CQI as an example to introduce a non-restrictive implementation:
the first node first performs a channel measurement for a CSI-RS resource to obtain a channel parameter matrix H_{r×t}, where r and t are a number of receiving antennas and a number of antenna ports used for transmission, respectively; under the condition of using a precoding matrix W_{t×l}, a channel parameter matrix after precoding is H_{r×t}·W_{t×l}, where l is rank or a number of layers; an equivalent channel capacity of H_{r×t}·W_{t×l} is calculated using, for example, SINR, EESM (Exponential Effective SINR Mapping), or RBIR (Received Block mean mutual Information Ratio) criterion, and then, CQI is determined by the equivalent channel capacity through methods such as table lookup. In general, the calculation of the equivalent channel capacity requires the first node to estimate noise and interference. In general, a mapping between the equivalent channel capacity and a value of the CQI depends on hardware related factors such as receiver performance or modulation mode. The precoding matrix W_{t×t} is usually fed back by the first node through RI or PMI.

Compared with CQI, L1-SINR does not carry information of the receiver, so the calculation of the equivalent channel capacity above is omitted.

In one embodiment, the measurement executed on the first CSI resource group is used to estimate the channel parameter matrix H_{r×t}.

In one embodiment, the measurement executed on the first CSI resource group is used to estimate the interference and/or noise.

In one embodiment, the first DCI only schedules PUSCHs on the K cells.

In one embodiment, the first DCI schedules a PUSCH on at least one cell other than the K cells.

In one embodiment, the first DCI schedules K PUSCHs, and the K PUSCHs are located on the K cells respectively.

In one embodiment, the first DCI comprises scheduling information of the K PUSCHs.

In one embodiment, the scheduling information comprises one or more of time-domain resources, frequency-domain resources, MCS (Modulation and Coding Scheme), DMRS (DeModulation Reference Signals) port, HARQ (Hybrid Automatic Repeat request) process number, RV (Redundancy version), NDI (New data indicator), or TCI (Transmission Configuration Indicator) state.

In one embodiment, the K PUSCHs are respectively transmitted on the K cells.

In one embodiment, frequency-domain resources occupied by the K PUSCHs belong to the K cells respectively.

In one embodiment, the K PUSCHs are respectively the PUSCHs on the K cells.

In one embodiment, the K PUSCHs are respectively the PUSCHs on the K cells scheduled by the first DCI.

In one embodiment, a given PUSCH is any PUSCH among the K PUSCHs, and the given PUSCH is on a given cell among the K cells; a cell identity of the given cell or a higher-layer parameter “dataScramblingIdentityPUSCH” configured for the given cell is used to determine a scrambling sequence of the given PUSCH.

In one embodiment, a given PUSCH is any PUSCH among the K PUSCHs, and the given PUSCH is on a given cell among the K cells; one of a cell identity of the given cell, a higher-layer parameter “scrumblingID0” configured for the given cell, or a higher-layer parameter “scrumblingID1” configured for the given cell is used to determine a DMRS sequence of the given PUSCH.

In one embodiment, the cell identity refers to a physical-layer cell identity.

In one embodiment, the cell identity refers to a PCI (Physical Cell Identity).

In one embodiment, a first PUSCH is a PUSCH on the first cell among the K PUSCHs, and the first CSI set is transmitted on the first PUSCH.

In one subembodiment of the above embodiment, the first CSI set is transmitted on only the first PUSCH among the K PUSCHs.

In one subembodiment of the above embodiment, the first CSI set occupies and only occupies an RE allocated to the first PUSCH.

In one embodiment, there exist time-domain resources occupied by two PUSCHs in the K PUSCHs are overlapping.

In one embodiment, time-domain resources occupied by any two of the K PUSCHs are overlapping.

In one embodiment, the K PUSCHs occupy same time-domain resources.

In one embodiment, HARQ process numbers corresponding to the K PUSCHs are configured separately.

In one embodiment, NDIs corresponding to the K PUSCHs are configured separately.

In one embodiment, RVs corresponding to the K PUSCHs are configured separately.

In one embodiment, the first DCI only schedules the K PUSCHs.

In one embodiment, the first DCI schedules at least one PUSCH other than the K PUSCHs, and any PUSCH in the at least one other PUSCH is on a cell other than the K cells.

In one subembodiment of the above embodiment, the first DCI comprises scheduling information for any of the at least one other PUSCH.

In one embodiment, the second field in the first DCI is used by the first node to determine an interpretation of the first field in the first DCI.

In one embodiment, a candidate value of the first field in the first DCI comprises N candidate values, N being a positive integer greater than 1; the N candidate values correspond to N CSI-ReportConfig sets respectively; a CSI-ReportConfig corresponding to the first CSI belongs to a CSI-ReportConfig set corresponding to a value of the first field in the first DCI among the N CSI-ReportConfig sets; a correspondence of the N candidate values and the N CSI-ReportConfig sets is configured by a first IE; any of the N CSI-ReportConfig sets comprises at least one CSI-ReportConfig.

In one subembodiment of the above embodiment, the N candidate values respectively indicate the N CSI-ReportConfig sets.

In one subembodiment of the above embodiment, a name of the first IE includes “CSI-AperiodicTriggerStateList”.

In one subembodiment of the above embodiment, the first IE is a CSI-AperiodicTriggerStateList IE.

In one subembodiment of the above embodiment, a CSI-ReportConfig corresponding to any CSI in the first CSI set belongs to a CSI-ReportConfig set corresponding to a value of the first field in the first DCI among the N CSI-ReportConfig sets.

In one subembodiment of the above embodiment, the first IE is one of M candidate IEs, M being a positive integer greater than 1; the M candidate IEs correspond one-to-one with M cells, and the M candidate IEs are respectively configured for the M cells.

In one reference embodiment of the above subembodiment, the second field in the first DCI is used to determine the first IE from the M candidate IEs.

In one reference embodiment of the above subembodiment, the M cells comprise the first cell, and the first IE is a candidate IE corresponding to the first cell among the M candidate IEs.

In one reference embodiment of the above subembodiment, the first DCI is transmitted on a second cell, and the M cells comprise the second cell; the first IE is a candidate IE corresponding to the second cell among the M candidate IE.

In one reference embodiment of the above subembodiment, the M candidate IEs respectively comprise CSI-AperiodicTriggerStateList IEs configured for the M cells.

In one embodiment, the first message set comprise M messages, M being a positive integer greater than 1; the first message is one of the M messages; the M messages correspond one-to-one with M cells, and the M messages are respectively configured for the M cells.

In one subembodiment of the above embodiment, the second field in the first DCI is used to determine the first message from the M messages.

In one subembodiment of the above embodiment, the first message is a message configured for the first cell among the M messages.

In one subembodiment of the above embodiment, the first DCI is transmitted on a second cell, and the first message is a message configured for the second cell among the M messages.

In one subembodiment of the above embodiment, the M messages respectively belong to M ServingCellConfig IEs, and the M ServingCellConfig IEs are respectively used to configure the M cells.

In one subembodiment of the above embodiment, the first node determines a CSI-ReportConfig corresponding to the first CSI by determining the first message.

In one subembodiment of the above embodiment, the first node determines a CSI-MeasConfig IE to which a CSI-ReportConfig corresponding to the first CSI belongs by determining the first message.

In one subembodiment of the above embodiment, there exist two of the M messages being transmitted in different PDSCHs.

In one subembodiment of the above embodiment, there exist two of the M messages being transmitted in a same PDSCH.

In one embodiment, the second field of the first DCI is used to determine the first cell from the K cells.

In one embodiment, the second field of the first DCI is used by the first node to determine the first cell from the K cells.

In one embodiment, the meaning of the phrase that the second field of the first DCI is used to determine the first cell includes: the second field of the first DCI is used to determine that the first CSI set is transmitted on the PUSCH of the first cell.

In one embodiment, the meaning of the phrase that the second field of the first DCI is used to determine the first cell includes: the second filed of the first DCI is used to determine that the first CSI set is transmitted on the PUSCH of the first cell in the K cells.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the gNB 203.

In one embodiment, a radio link between the UE 201 and the gNB 203 comprises a cellular network link.

In one embodiment, a transmitter of the first message set comprises the gNB 203.

In one embodiment, a receiver of the first information set comprises the UE 201.

In one embodiment, a transmitter of the first DCI comprises the gNB 203.

In one embodiment, a receiver of the first DCI comprises the UE 201.

In one embodiment, a transmitter of the first CSI set comprises the UE 201.

In one embodiment, a receiver of the first CSI set comprises the gNB 203.

In one embodiment, the UE 201 supports one DCI scheduling PDSCHs/PUSCHs of multiple cells.

### Embodiment 3

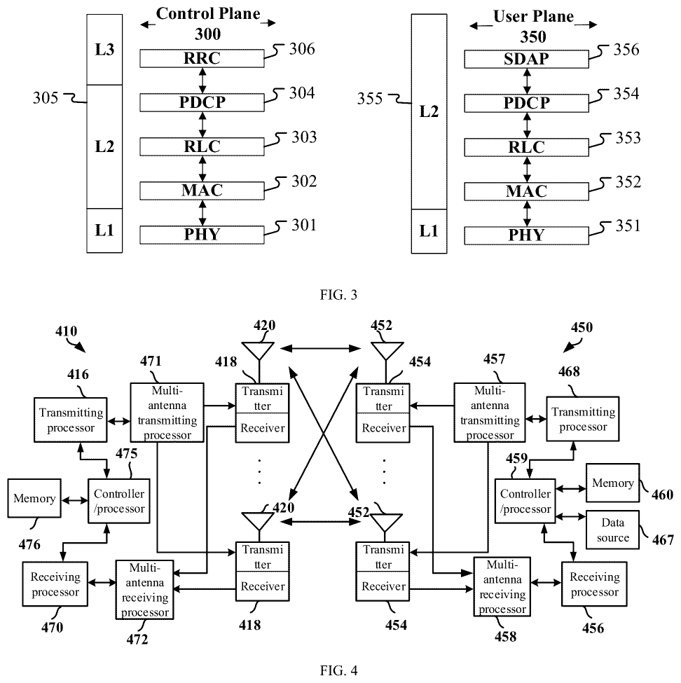

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first message set is generated by the RRC sublayer 306.

In one embodiment, the first DCI is generated by the PHY 301 or the PHY 351.

In one embodiment, the first CSI set is generated by the PHY 301 or the PHY 351.

In one embodiment, the higher layer in the present application refers to a layer above the physical layer.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives the first message set and the first DCI, and executes a measurement on the first RS resource group; transmits a first CSI set on a PUSCH of the first cell; the first message set comprises a first message, the first DCI comprises a first field and a second field; the first CSI set comprises a first CSI; the first DCI is used to schedule PUSCHs on at least K cells, K being a positive integer greater than 1; the first cell is one of the K cells; the first field of the first DCI is used to trigger the first CSI; the second field of the first DCI is used to determine the first cell; the measurement performed on the first RS resource group is used to calculate the first CSI, and the first message is used to indicate the first RS resource group.

In one embodiment, the second communication device 450 comprises a memory that stores a computer readable instruction program. The computer readable instruction program generates an action when executed by at least one processor. The action includes: receiving the first message set and the first DCI, and executing a measurement on the first RS resource group; transmitting the first CSI set on a PUSCH of the first cell.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits the first message set and the first DCI; receives the first CSI set on a PUSCH of the first cell; the first message set comprises a first message, the first DCI comprises a first field and a second field; the first CSI set comprises a first CSI; the first DCI is used to schedule PUSCHs on at least K cells, K being a positive integer greater than 1; the first cell is one of the K cells; the first field of the first DCI is used to trigger the first CSI; the second field of the first DCI is used to determine the first cell; a measurement performed on a first RS resource group is used to calculate the first CSI, and the first message is used to indicate the first RS resource group.

In one embodiment, the first communication device 410 comprises a memory that stores a computer readable instruction program. The computer readable instruction program generates an action when executed by at least one processor. The action includes: transmitting the first message set and the first DCI; receiving the first CSI set on a PUSCH of the first cell.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first message set in the present application; at least one of the antenna 420, the transmitter 418, the transmitting processor 416, the multi-antenna transmitting processor 471, the controller/processor 475, or the memory 476 is used to transmit the first message set.

In one embodiment, at least one of the antenna 452, the receiver 454, the receiving processor 456, the multi-antenna receiving processor 458, the controller/processor 459, the memory 460, or the data source 467 is used to receive the first DCI; at least one of the antenna 420, the transmitter 418, the transmitting processor 416, the multi-antenna transmitting processor 471, the controller/processor 475, or the memory 476 is used to transmit the first DCI.

In one embodiment, at least one of the antenna 452, the receiver 454, the receiving processor 456, the multi-antenna receiving processor 458, the controller/processor 459, the memory 460, or the data source 467 is used for executing the measurement on the first RS resource group.

In one embodiment, at least one of the antenna 420, the receiver 418, the receiving processor 470, the multi-antenna receiving processor 472, the controller/processor 475, or the memory 476 is used to receive the first CSI set on a PUSCH of the first cell; at least one of the antenna 452, the transmitter 454, the transmitting processor 468, the multi-antenna transmitting processor 457, the controller/processor 459, the memory 460, or the data source 467 is used to transmit the first CSI set on a PUSCH of the first cell.

### Embodiment 5

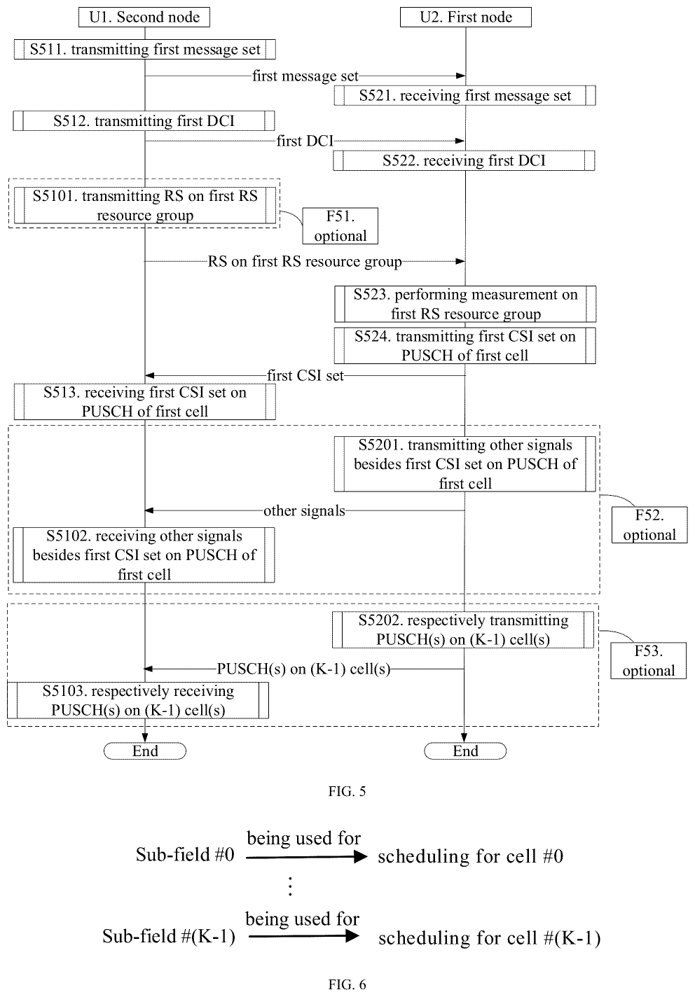

Embodiment 5 illustrates a flowchart of transmission according to one embodiment of the present application, as shown in FIG. 5. In FIG. 5, a second node U1 and a first node U2 are communication nodes transmitted via an air interface. In FIG. 5, each step in block F51 to block F53 is optional.

The second node U1 transmits a first message set in step S511; transmits a first DCI in step S512; transmits an RS on a first RS resource group in step S5101; in step S513, receives a first CSI set on a PUSCH of a first cell; in step S5102, receives a signal other than the first CSI set on the PUSCH of the first cell; in step S5103, respectively receives PUSCH(s) on (K−1) cell(s).

The first node U2 receives a first message set in step S521; receives a first DCI in step S522; executes a measurement on a first RS resource group in step S523; transmits a first CSI set on a PUSCH of a first cell in step S524; transmits a signal other than the first CSI set on the PUSCH of the first cell in step S5201; respectively transmits PUSCH(s) on (K−1) cell(s) in step S5202.

In embodiment 5, the first message set comprises a first message, and the first DCI comprises a first field and a second field; the first CSI set comprises a first CSI; the first DCI is used to schedule PUSCHs on at least K cells, K being a positive integer greater than 1; the first cell is one of the K cells; the first field of the first DCI is used to trigger the first CSI; the second field of the first DCI is used by the first node U2 to determine the first cell; the measurement performed on the first RS resource group is used by the first node U2 to calculate the first CSI, and the first message is used to indicate the first RS resource group.

In one embodiment, the first node U2 is the first node in the present application.

In one embodiment, the second node U1 is the second node in the present application.

In one embodiment, an air interface between the second node U1 and the first node U2 comprises a radio interface between a base station and a UE.

In one embodiment, an air interface between the second node U1 and the first node U2 comprises a radio interface between a relay node and a UE.

In one embodiment, an air interface between the second node U1 and the first node U2 comprises a radio interface between a UE and a UE.

In one embodiment, the second node U1 is a serving cell maintenance base station of the first node U2.

In one embodiment, the first DCI is used by the second node U1 to schedule PUSCHs on at least K cells.

In one embodiment, the first message set is transmitted in a PDSCH.

In one embodiment, the first message is transmitted in a PDSCH.

In one embodiment, each message in the first message set is transmitted in a PDSCH.

In one embodiment, the first DCI is transmitted in a PDCCH.

In one embodiment, step in block F51 in FIG. 5 exists, and the method in a second node for wireless communications comprises: transmitting an RS on the first RS resource group.

In one subembodiment of the above embodiment, an RS is transmitted on at least one RS resource in the first RS resource group.

In one embodiment, steps in block F52 in FIG. 5 exist, and the method in a first node for wireless communications comprises: transmitting a signal other than the first CSI set on the PUSCH of the first cell.

In one embodiment, steps in block F52 in FIG. 5 exist, and the method in a second node for wireless communications comprises: receiving a signal other than the first CSI set on the PUSCH of the first cell.

In one embodiment, steps in block F53 in FIG. 5 exist, and the method in a first node for wireless communications comprises: respectively transmitting PUSCH(s) on (K−1) cell(s); the (K−1) cell(s) consists (consist) of all cells except the first cell among the K cells.

In one embodiment, the PUSCH(s) respectively transmitted on the (K−1) cell(s) is (are respectively) PUSCH(s) on the (K−1) cell(s) scheduled by the first DCI.

In one embodiment, the PUSCH(s) respectively transmitted on the (K−1) cell(s) is (are respectively) PUSCH(s) on the (K−1) cell(s) among the K PUSCHs.

In one embodiment, steps in block F53 in FIG. 5 exists, and the method in a second node for wireless communications comprises: respectively receiving PUSCH(s) on (K−1) cell(s); the (K−1) cell(s) consists (consist) of all cells except the first cell among the K cells.

### Embodiment 6

Embodiment 6 illustrates a schematic diagram of K sub-fields according to one embodiment of the present application, as shown in FIG. 6. In embodiment 6, the first DCI comprises K sub-fields, and the K sub-fields are respectively used for scheduling for the K cells. In FIG. 6, the K sub-fields are respectively denoted as sub-field #0, . . . , sub-field #(K−1); the K cells are respectively denoted as cell #0, . . . , cell #(K−1).

In one embodiment, the K sub-fields respectively comprise at least one bit.

In one embodiment, any one of the K sub-fields comprises partial or all bits in a DCI field.

In one embodiment, any one of the K sub-fields comprises partial bits in a DCI field.

In one embodiment, any one of the K sub-fields comprises a DCI field.

In one embodiment, any one of the K sub-fields is a DCI field.

In one embodiment, there exist two sub-fields in the K sub-fields respectively comprising different bits in a same DCI field.

In one embodiment, the K sub-fields respectively comprise different bits in a same DCI field.

In one embodiment, there exist two sub-fields in the K sub-fields respectively comprising two different DCI fields.

In one embodiment, the K sub-fields respectively comprise K different DCI fields.

In one embodiment, the K sub-fields are respectively K different DCI fields.

In one embodiment, the first DCI comprises P different DCI fields, P being a positive integer greater than 1; any of the K sub-fields comprises partial bits in each DCI field in the P different DCI fields.

In one subembodiment of the above embodiment, for any given DCI field of the P different DCI fields, any two of the K sub-fields comprise different (one or more) bits in the given DCI field.

In one embodiment, the K sub-fields are arranged in order in the first DCI.

In one embodiment, the second field in the first DCI comprises the K sub-fields.

In one embodiment, the second field in the first DCI comprises only partial sub-fields in the K sub-fields.

In one embodiment, the second field in the first DCI consists of the K sub-fields.

In one embodiment, the second field in the first DCI comprises all or partial bits in a DCI field different from the K sub-fields.

In one embodiment, the second field in the first DCI comprises all or partial bits in a third field, the third field is a DCI field, and the third field does not comprise a bit in any of the K sub-fields.

In one subembodiment of the above embodiment, the third field does not comprise a bit in a DCI field to which any of the K sub-fields belongs.

### Embodiment 7

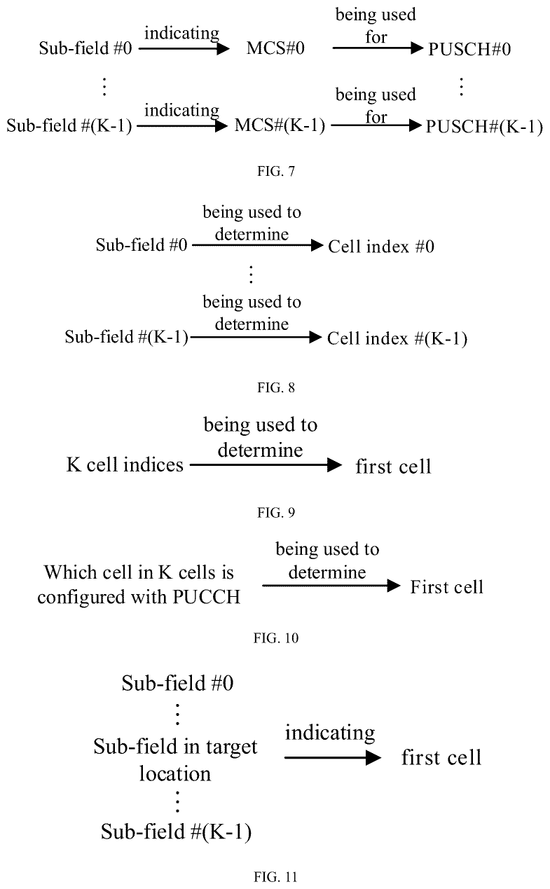

Embodiment 7 illustrates a schematic diagram of K sub-fields respectively indicating K MCSs according to one embodiment of the present application, as shown in FIG. 7. In embodiment 7, the K sub-fields respectively indicate K MCSs, the K MCSs are respectively used for K PUSCHs, and the K PUSCHs are respectively on the K cells. In FIG. 7, the K sub-fields are respectively denoted as sub-field #0, . . . , sub-field #(K−1); the K MCS are respectively denoted as MCS #0, . . . , MCS #(K−1); the K PUSCHs are denoted as PUSCH #0, . . . , PUSCH #(K−1), respectively.

In one embodiment, the MCS refers to Modulation and Coding Scheme.

In one embodiment, any sub-field in the K sub-fields comprises all or partial bits in a DCI field Modulation and coding scheme.

In one embodiment, the K sub-fields each comprise different bits in a DCI field Modulation and coding scheme.

In one embodiment, the K sub-fields each comprise all or partial bits in K DCI fields Modulation and coding scheme.

In one embodiment, the K sub-fields each comprise K DCI fields Modulation and Coding Scheme.

In one embodiment, the K sub-fields are respectively K DCI fields Modulation and Coding Scheme.

In one embodiment, the K sub-fields respectively indicate MCS indices corresponding to the K MCSs.

In one embodiment, the K MCSs are respectively MCSs of the K PUSCHs.

In one embodiment, there exist two different MCSs among the K MCSs.

In one embodiment, there exist two same MCSs among the K MCSs.

In one embodiment, frequency-domain resources occupied by the K PUSCHs belong to the K cells respectively.

In one embodiment, the K PUSCHs are respectively transmitted on the K cells.

In one embodiment, the K MCSs are used to determine the first cell.

In one embodiment, the K MCSs are used to determine that the first CSI set is transmitted on the PUSCH of the first cell in the K cells.

In one embodiment, the meaning of the phrase that the second field of the first DCI is used to determine the first cell includes: the second field comprises at least one of the K sub-fields, the K sub-fields respectively indicate the K MCSs, and the K MCSs are used to determine the first cell.

In one embodiment, the meaning of the phrase that the second field of the first DCI is used to determine the first cell includes: the second field comprises at least one of the K sub-fields, the K sub-fields respectively indicate the K MCSs, and the K MCSs are used to determine that the first CSI set is transmitted on the PUSCH of the first cell among the K cells.

In one embodiment, the first node determines the first cell according to the K MCSs.

In one embodiment, among the K cells, a cell with a higher MCS is prioritized as the first cell.

In one embodiment, the first cell is a cell with a highest MCS in the K cells.

In one embodiment, the first cell is a cell with a largest MCS index in the K cells.

In one embodiment, the first cell is a cell with a largest frequency-domain efficiency of an MCS in the K cells.

In one embodiment, a first MCS in the K MCSs is used for the PUSCH on the first cell, and the first MCS is a highest one among the K MCSs.

In one embodiment, the meaning of an MCS is higher than another MCS includes: an MCS index of the MCS is greater than an MCS index of the another MCS; the MCS and the another MCS belong to a same MCS index table.

In one embodiment, the meaning of an MCS being higher than another MCS includes: spectral efficiency of the MCS is greater than spectral efficiency of the another MCS.

In one embodiment, when all other parameters are the same, a cell with a higher MCS among the K cells is prioritized as the first cell.

In one subembodiment of the above embodiment, the other parameters comprise parameters that affect a determination of the first cell and are other than an MCS.

In one subembodiment of the above embodiment, the other parameters comprise priority.

In one subembodiment of the above embodiment, the other parameters comprise cell index.

In one subembodiment of the above embodiment, the other parameters comprise whether a PUCCH is configured.

In one subembodiment of the above embodiment, the K cells have the same other parameters.

In one subembodiment of the above embodiment, the first cell is a cell with highest MCS among the K cells.

In one subembodiment of the above embodiment, the first DCI is used to schedule PUSCHs on K4 cells, K4 being a positive integer greater than K and at least one of the K4 cells does not belong to the K cells; the K cells consist of all cells having the same other parameters in the K4 cells.

In one embodiment, when there exist K1 cells in the K cells whose MCSs are the same as a highest MCS among the K MCSs and K1 is a positive integer greater than 1, other parameters are used to determine the first cell.

In one subembodiment of the above embodiment, the other parameters comprise parameters that affect a determination of the first cell and are outside of an MCS.

In one subembodiment of the above embodiment, the other parameters comprise priority.

In one subembodiment of the above embodiment, the other parameters comprise cell index.

In one subembodiment of the above embodiment, the other parameters comprise whether a PUCCH is configured.

In one subembodiment of the above embodiment, the other parameters are used to determine the first cell from the K1 cells.

In one embodiment, the meaning of two MCSs being the same includes: the two MCSs belong to a same MCS index table and have a same MCS index.

In one embodiment, the meaning of two MCSs being the same includes: spectral efficiency of the two MCSs is the same.

In one embodiment, MCSs of the K cells are respectively the K MCSs.

In one embodiment, when there exist K1 cells in the K cells whose MCSs are the same as a highest MCS among the K MCSs and K1 is a positive integer greater than 1, cell indices of the K1 cells are used to determine the first cell from the K1 cells.

In one subembodiment of the above embodiment, the first cell is a cell with a smallest cell index in the K1 cells.

In one subembodiment of the above embodiment, the first cell is a cell with a largest cell index in the K1 cells.

In one embodiment, when there exist K1 cells in the K cells whose MCSs are the same as a highest MCS among the K MCSs and K1 is a positive integer greater than 1, the first cell is a cell configured with a PUCCH in the K1 cells.

In one embodiment, when there exist K1 cells in the K cells whose MCSs are the same as a highest MCS among the K MCSs and K1 is a positive integer greater than 1, the first cell is a cell with a highest priority in the K1 cells.

In one embodiment, when there exist K1 cells in the K cells whose MCSs are the same as a highest MCS among the K MCSs and K1 is a positive integer greater than 1, the first cell is a cell indicated by a sub-field ranked first in the first DCI among the K1 sub-fields; the K1 sub-fields are sub-fields respectively used for scheduling for the K1 cells among the K sub-fields.

In one embodiment, when there exist K1 cells in the K cells whose MCSs are the same as a highest MCS among the K MCSs and K1 is a positive integer greater than 1, the first cell is a cell indicated by a sub-field ranked last in the first DCI among the K1 sub-fields; the K1 sub-fields are sub-fields respectively used for scheduling for the K1 cells among the K sub-fields.

### Embodiment 8

Embodiment 8 illustrates a schematic diagram of K sub-fields being respectively used to determine K cell indices according to one embodiment of the present application, as shown in FIG. 8. In embodiment 8, the K sub-fields are respectively used by the first node to determine K cell indices, and the K cell indices are respectively assigned to the K cells. In FIG. 8, the K sub-fields are respectively denoted as sub-field #0, . . . , sub-field #(K−1); the K cell indices are denoted as cell index #0, . . . , and cell index #(K−1), respectively.

In one embodiment, any of the K sub-fields comprises all or partial bits in a DCI field Carrier indicator.

In one embodiment, the K sub-fields respectively comprise different bits in a DCI field Carrier Indicator.

In one embodiment, the K sub-fields respectively comprise all or partial bits in K DCI fields Carrier indicator.

In one embodiment, the K sub-fields respectively comprise K DCI fields Carrier indicator.

In one embodiment, the K sub-fields are respectively K DCI fields Carrier indicator.

In one embodiment, any one of the K cell indices is a ServCellIndex or SCellIndex.

In one embodiment, for definitions of the ServCellIndex and the SCellIndex, refer to 3GPP TS38.331.

In one embodiment, the K cell indices are respectively non-negative integers.

In one embodiment, the K cell indices are non-negative integers not greater than 32.

In one embodiment, the K cell indices are not equal to each other.

In one embodiment, the K cell indices are respectively used to identify the K cells.

In one embodiment, the K cell indices are cell indices of the K cells, respectively.

In one embodiment, the K sub-fields respectively indicate the K cell indices.

In one embodiment, the K sub-fields respectively and explicitly indicate the K cell indices.

In one embodiment, the K sub-fields respectively indicate code-points of Carrier indicator fields corresponding to K cell indices.

In one embodiment, the K sub-fields respectively indicate values of Carrier indicator fields corresponding to K cell indices.

In one embodiment, the K sub-fields respectively and implicitly indicate the K cell indices.

In one embodiment, the K sub-fields are used to determine the K cells.

In one embodiment, the second field of the first DCI is used to determine the K cells.

In one embodiment, the K sub-fields respectively indicate the K cells.

In one embodiment, the K sub-fields belong to K0 sub-fields, K0 being a positive integer not less than K; the K0 sub-fields respectively correspond to K0 cell indices, and the K cell indices belong to the K0 cell indices; for any given cell index in the K0 cell indices, when a value of a sub-field corresponding to the given cell index in the K0 sub-fields is equal to a first value, a cell identified by the given cell index is one of the K cells; when a value of a sub-field corresponding to the given cell index in the K0 sub-fields is not equal to the first value, the cell identified by the given cell index does not belong to the K cells.

In one subembodiment of the above embodiment, the K0 sub-fields are each K0 bits, and the first value is equal to 1.

In one subembodiment of the above embodiment, the K0 sub-fields are each K0 bits, and the first value is equal to 0.

In one subembodiment of the above embodiment, a corresponding relation between the K0 sub-fields and the K0 cell indices is configured by a higher-layer signaling.

In one embodiment, the K cell indices are used to determine the first cell.

In one embodiment, the K cell indices are used to determine which first CSI set is transmitted on the PUSCH of the first cell in the K cells.

In one embodiment, the meaning of the phrase that the second field of the first DCI is used to determine the first cell includes: the second field comprises at least one of the K sub-fields, the K sub-fields are respectively used to determine the K cell indices, and the K cell indices are used to determine the first cell.

In one embodiment, the meaning of the phrase that the second field of the first DCI is used to determine the first cell includes: the second field comprises at least one of the K sub-fields, the K sub-fields are respectively used to determine the K cell indices, and the K cell indices are used to determine that the first CSI set is transmitted on the PUSCH of the first cell in the K cells.

In one embodiment, which of the K cells is configured with a PUCCH is used to determine the first cell.

In one embodiment, which one of the K cells is configured with a PUCCH is used to determine that the first CSI set is transmitted on the PUSCH of the first cell in the K cells.

In one embodiment, one of the K cells is configured with a PUCCH.

In one embodiment, only one of the K cells is configured with a PUCCH.

In one embodiment, the meaning of the phrase that the second field of the first DCI is used to determine the first cell includes: the second field comprises at least one of the K sub-fields, the K sub-fields are respectively used to determine the K cell indices, and which one of the K cells is configured with a PUCCH is used to determine the first cell.

In one embodiment, the meaning of the phrase that the second field of the first DCI is used to determine the first cell includes: the second field comprises at least one of the K sub-fields, and the K sub-fields are respectively used to determine the K cell indices, which one of the K cells is configured with a PUCCH is used to determine that the first CSI set is transmitted on the PUSCH of the first cell in the K cells.

In one embodiment, the first cell is a cell configured with a PUCCH in the K cells.

In one embodiment, the first cell is only one cell configured with a PUCCH in the K cells.

In one embodiment, the meaning of the phrase that the second field of the first DCI is used to determine the first cell includes: the second field comprises at least one of the K sub-fields, the K sub-fields are respectively used to determine the K cell indices, and the first cell is a cell indicated by a sub-field located at the target location in the K sub-fields.

In one embodiment, the meaning of the phrase that the second field of the first DCI is used to determine the first cell includes: the second field comprises at least one of the K sub-fields, the K sub-fields are respectively used to determine the K cell indices, and the first CSI set is transmitted on the PUSCH of a cell indicated by a sub-field located at the target location in the K sub-fields.

### Embodiment 9

Embodiment 9 illustrates a schematic diagram of K cell indices being used to determine a first cell according to one embodiment of the present application, as shown in FIG. 9.

In one embodiment, the K cell indices are used by the first node to determine the first cell.

In one embodiment, the first node determines the first cell according to the K cell indices.

In one embodiment, among the K cells, a cell with a smaller cell index is prioritized as the first cell.

In one embodiment, among the K cells, a cell with a larger cell index is prioritized as the first cell.

In one embodiment, the first cell is a cell corresponding to a smallest cell index among the K cells.

In one embodiment, the first cell is a cell corresponding to a largest cell index cell in the K cells.

In one embodiment, when all other parameters are the same, a cell with a smaller cell index among the K cells is prioritized as the first cell.

In one embodiment, when all other parameters are the same, a cell with a larger cell index among the K cells is prioritized as the first cell.

In one embodiment, the other parameters comprise parameters that affect a determination of the first cell and are outside a cell index.

In one embodiment, the other parameters comprise priority.

In one embodiment, the other parameters comprise MCS.

In one embodiment, the other parameters comprise whether a PUCCH is configured.

In one embodiment, the K cells have the same other parameters.

In one embodiment, the first DCI is used to schedule PUSCHs on K4 cells, K4 being a positive integer greater than K, and at least one of the K4 cells does not belong to the K cells; the K cells consist of cells having the same other parameters in the K4 cells.

### Embodiment 10

Embodiment 10 illustrates a schematic diagram of which cell among K cells is configured with a PUCCH being used to determine a first cell according to one embodiment of the present application, as shown in FIG. 10.

In one embodiment, which of the K cells is configured with a PUCCH is used by the first node to determine the first cell.

In one embodiment, only one of the K cells is configured with a PUCCH.

In one embodiment, there exist multiple cells in the K cells being configured with a PUCCH.

In one embodiment, the first node determines the first cell according to which one of the K cells is configured with a PUCCH.

In one embodiment, the first cell is a cell configured with a PUCCH in the K cells.

In one embodiment, the first cell is only one cell configured with a PUCCH in the K cells.

In one embodiment, the first node determines the first cell according to which of the K cells are configured with PUCCHs.

In one embodiment, among the K cells, a cell configured with a PUCCH is prioritized as the first cell.

In one embodiment, when all other parameters are the same, a cell configured with a PUCCH among the K cells is prioritized as the first cell.

In one subembodiment of the above embodiment, the other parameters comprise parameters other than affecting a determination of the first cell and whether a PUCCH is configured.

In one subembodiment of the above embodiment, the other parameters comprise priority.

In one subembodiment of the above embodiment, the other parameters comprise MCS.

In one subembodiment of the above embodiment, the other parameters comprise cell index.

In one subembodiment of the above embodiment, the K cells have the same other parameters.

In one embodiment, when there exist K3 cells being configured with a PUCCH in the K cells and K3 is a positive integer greater than 1, other parameters are used to determine the first cell.

In one subembodiment of the above embodiment, the other parameters are used to determine the first cell from the K3 cells.

In one subembodiment of the above embodiment, the other parameters comprise parameters other than affecting a determination of the first cell and whether a PUCCH is configured.

In one subembodiment of the above embodiment, the other parameters comprise priority.

In one subembodiment of the above embodiment, the other parameters comprise MCS.

In one subembodiment of the above embodiment, the other parameters comprise cell index.

In one embodiment, when there exist K3 cells being configured with a PUCCH in the K cells and K3 is a positive integer greater than 1, MCSs of the K3 cells are used to determine the first cell.

In one subembodiment of the above embodiment, the first cell is a cell with a highest MCS among the K3 cells.

In one embodiment, when there exist K3 cells being configured with a PUCCH in the K cells and K3 is a positive integer greater than 1, cell indices of the K3 cells are used to determine the first cell.

In one subembodiment of the above embodiment, the first cell is a cell with a smallest cell index in the K3 cells.

In one subembodiment of the above embodiment, the first cell is a cell with a largest cell index in the K3 cells.

In one embodiment, when there exist K3 cells being configured with a PUCCH in the K cells and K3 is a positive integer greater than 1, the first cell is a cell with a highest priority in the K3 cells.

In one embodiment, when there exist K3 cells among the K cells being configured with PUCCHs and K3 is a positive integer greater than 1, the first cell is a cell indicated by a sub-field ranked first in the first DCI among K3 sub-fields; the K3 sub-fields are sub-fields respectively used for scheduling for the K3 cells among the K sub-fields.

In one embodiment, when there exist K3 cells among the K cells being configured with PUCCHs and K3 is a positive integer greater than 1, the first cell is a cell indicated by a sub-field ranked last in the first DCI among K3 sub-fields; the K3 sub-fields are sub-fields respectively used for scheduling for the K3 cells among the K sub-fields.

### Embodiment 11

Embodiment 11 illustrates a schematic diagram of a first cell being a cell indicated by a sub-field located at a target location in K sub-fields according to one embodiment of the present application, as shown in FIG. 11. In embodiment 11, the target location is default. In FIG. 11, the K sub-fields are respectively denoted as sub-field #0, . . . , sub-field #(K−1).

In one embodiment, the meaning of the phrase that the target location is default includes: the target location does not require configuration.

In one embodiment, the meaning of the phrase that the target location is default includes: the target location is default.

In one embodiment, the meaning of the phrase that the target location is default includes: the target location is a location of an earliest sub-field among the K sub-fields.

In one embodiment, the meaning of the phrase that the target location is default includes: the target location is a location of a last sub-field among the K sub-fields.

In one embodiment, the meaning of the phrase that the target location is default includes: the K sub-fields are respectively K bits, and the target location is a location of a Most Significant Bit (MSB) among the K bits.

In one embodiment, the meaning of the phrase that the target location is default includes: the K sub-fields are respectively K bits, and the target location is a location of a Least Significant Bit (LSB) among the K bits.

In one embodiment, the meaning of the phrase that the target location is default includes: the target location is a location where a sub-field comprising MSBs of the K sub-fields among the K sub-fields is located.

In one embodiment, the meaning of the phrase that the target location is default includes: the target location is a location where a sub-field of an LSB including the K sub-fields is located.

In one embodiment, the meaning of the phrase that the target location is default includes: the target location is a location of a sub-field ranked first in the first DCI among the K sub-fields.

In one embodiment, the meaning of the phrase that the target location is default includes: the target location is a location of a sub-field ranked second in the first DCI among the K sub-fields.

In one embodiment, the meaning of the phrase that the target location is default includes: the target location is a location of a sub-field ranked last in the first DCI among the K sub-fields.

In one embodiment, the meaning of the phrase that the target location is default includes: the target location is a location of a sub-field ranked second-to-last in the first DCI among the K sub-fields.

In one embodiment, the target location is a location of a sub-field nearest to an MSB of the first DCI among the K sub-field.

In one embodiment, the target location is a location of a sub-field nearest to an LSB of the first DCI among the K sub-field.

### Embodiment 12

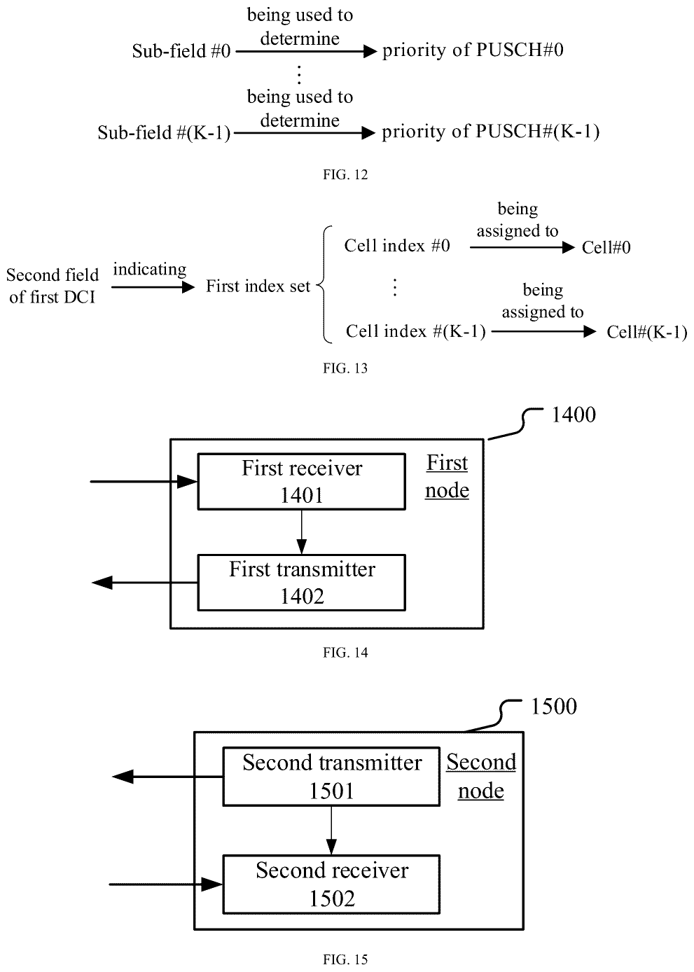

Embodiment 12 illustrates a schematic diagram of K sub-fields respectively being used to determine priorities of K PUSCHs according to one embodiment of the present application, as shown in FIG. 12. In embodiment 12, the K sub-fields are respectively used by the first node to determine priorities of K PUSCHs; the K PUSCHs are located on the K cells respectively. In FIG. 12, the K sub-fields are denoted as sub-fields #0, . . . , and #(k−1) respectively; priorities of the K PUSCHs are respectively denoted as a priority of PUSCH #0, . . . , and a priority of PUSCH #(K−1).

In one embodiment, any of the K sub-fields comprises all or partial bits in a DCI field Priority indicator.

In one embodiment, the K sub-fields respectively comprise different bits in a DCI field priority indicator.

In one embodiment, the K sub-fields respectively comprise all or partial bits in K DCI fields priority indicator.

In one embodiment, the K sub-fields respectively comprise K DCI fields priority indicator.

In one embodiment, the K sub-fields are respectively K DCI fields priority indicator.

In one embodiment, frequency-domain resources occupied by the K PUSCHs belong to the K cells respectively.

In one embodiment, the K PUSCHs are respectively transmitted on the K cells.

In one embodiment, the K sub-fields respectively indicate priorities of the K PUSCHs.

In one embodiment, the K sub-fields respectively indicate K priority indices, and the K priority indices respectively indicate priorities of the K PUSCHs.

In one embodiment, any one of the K priority indices is a non-negative integer.

In one embodiment, any one of the K priority indices is equal to 0 or 1.

In one embodiment, there exist two equal priority indices among the K priority indices.

In one embodiment, there exist two unequal priority indices among the K priority indices.

In one embodiment, there exist two PUSCHs with a same priority among the K PUSCHs.

In one embodiment, there exist two PUSCHs with different priorities among the K PUSCHs.

In one embodiment, priorities of the K PUSCHs are used by the first node to determine the first cell.

In one embodiment, priorities of the K PUSCHs are used by the first node to determine that the first CSI set is transmitted on the PUSCH of the first cell among the K cells.

In one embodiment, the meaning of the phrase that the second field of the first DCI is used to determine the first cell includes: the second field comprises at least one of the K sub-fields, the K sub-fields are respectively used to determine priorities of the K PUSCHs, and priorities of the K PUSCHs are used to determine the first cell.

In one embodiment, the meaning of the phrase that the second field of the first DCI is used to determine the first cell includes: the second field comprises at least one of the K sub-fields, the K sub-fields are respectively used to determine priorities of the K PUSCHs, and priorities of the K PUSCHs are used to determine that the first CSI set is transmitted on the PUSCH of the first cell among the K cells.

In one embodiment, the first cell is a cell with a highest priority among the K cells.

In one embodiment, the first cell is a cell with a lowest priority in the K cells.

In one embodiment, among the K cells, a cell with a higher priority is prioritized as the first cell.

In one embodiment, among the K cells, a cell with a lower priority is prioritized as the first cell.

In one embodiment, when all other parameters are the same, a cell with a higher priority among the K cells is prioritized as the first cell.

In one subembodiment of the above embodiment, the other parameters comprise parameters affecting a determination of the first cell and other than a priority of a PUSCH.

In one subembodiment of the above embodiment, the other parameters comprise MCS.

In one subembodiment of the above embodiment, the other parameters comprise cell index.

In one subembodiment of the above embodiment, the other parameters comprise whether a PUCCH is configured.

In one subembodiment of the above embodiment, the K cells have the same other parameters.

In one subembodiment of the above embodiment, the first cell is a cell with highest priority among the K cells.

In one subembodiment of the above embodiment, the first DCI is used to schedule PUSCHs on K4 cells, K4 being a positive integer greater than K and at least one of the K4 cells does not belong to the K cells; the K cells consist of all cells having the same other parameters in the K4 cells.

In one embodiment, the meaning of a priority being higher than another priority includes: a priority index of the priority is greater than a priority index of the another priority.

In one embodiment, the meaning of a priority being higher than another priority includes: a priority index of the priority is less than a priority index of the another priority.

In one embodiment, when there are K2 cells among the K cells whose priorities are the same as a highest priority in priorities of the K PUSCHs and K2 is a positive integer greater than 1, other parameters are used to determine the first cell.

In one subembodiment of the above embodiment, the other parameters comprise parameters other than affecting a determination of the first cell and a priority of a PUSCH.

In one subembodiment of the above embodiment, the other parameters comprise MCS.

In one subembodiment of the above embodiment, the other parameters comprise cell index.

In one subembodiment of the above embodiment, the other parameters comprise whether a PUCCH is configured.

In one embodiment, the meaning of two priorities being the same includes: priority indices of the two priorities are equal.

In one embodiment, priorities of the K cells are respectively priorities of the K PUSCHs.

In one embodiment, when there are K2 cells among the K cells whose priorities are the same as a highest priority in priorities of the K PUSCHs and K2 is a positive integer greater than 1, MCSs of the K2 cells are used to determine the first cell from the K2 cells.

In one subembodiment of the above embodiment, the first cell is a cell with a highest MCS among the K2 cells.

In one embodiment, when there are K2 cells among the K cells whose priorities are the same as a highest priority in priorities of the K PUSCHs and K2 is a positive integer greater than 1, cell indices of the K2 cells are used to determine the first cell from the K2 cells.

In one subembodiment of the above embodiment, the first cell is a cell with a smallest cell index in the K2 cells.

In one subembodiment of the above embodiment, the first cell is a cell with a largest cell index in the K2 cells.

In one embodiment, when there are K2 cells among the K cells whose priorities are the same as a highest priority in priorities of the K PUSCHs and K2 is a positive integer greater than 1, the first cell is a cell indicated by a sub-field ranked first in the first DCI in K2 sub-fields, and the K2 sub-fields are sub-fields respectively used for scheduling for the K2 cells in the K sub-fields.

In one embodiment, the K sub-fields respectively indicate the K MCSs and are respectively used to determine the K cell indices.

In one embodiment, the K sub-fields respectively indicate the K MCSs and are respectively used to determine priorities of the K PUSCHs.

In one embodiment, the K sub-fields are respectively used to determine the K cell indices and are respectively used to determine priorities of the K PUSCHs.

In one embodiment, the K sub-fields respectively indicate the K MCSs, are respectively used to determine the K cell indices, and are respectively used to determine priorities of the K PUSCHs.

### Embodiment 13

Embodiment 13 illustrates a schematic diagram of a second field in a first DCI indicating a first index set according to one embodiment of the present application, as shown in FIG. 13. In embodiment 13, the first index set comprises K cell indices, and the K cell indices are respectively assigned to the K cells. In FIG. 13, the K cell indices are denoted as cell index #0, . . . , and cell index #(K−1) respectively; the K cells are respectively denoted as cell #0, . . . , cell #(K−1).

In one embodiment, any one of the K cell indices is a ServCellIndex or SCellIndex.

In one embodiment, the K cell indices are respectively non-negative integers.

In one embodiment, the K cell indices are respectively non-negative integers not greater than 32.

In one embodiment, the K cell indices are not equal to each other.

In one embodiment, the first index set consists of the K cell indices.

In one embodiment, the first index set comprises at least one cell index not belonging to the K cell indices.

In one embodiment, the first DCI schedules a PUSCH on at least one other cell besides the K cells, and the first index set comprises a cell index of each cell in the at least one other cell.

In one embodiment, the K cell indices are used to determine the first cell.

In one embodiment, the K cell indices are used to determine the first cell from the K cells.

In one embodiment, the K cell indices are used to determine that the first CSI set is transmitted on the PUSCH of the first cell in the K cells.

In one embodiment, the meaning of the phrase that the second field of the first DCI is used to determine the first cell includes: the second field in the first DCI indicates the first index set, the first index set comprises the K cell indices, and the K cell indices are respectively assigned to the K cells; the K cell indices are used to determine the first cell.

In one embodiment, among the K cells, a cell with a smaller cell index is prioritized as the first cell.

In one embodiment, among the K cells, a cell with a larger cell index is prioritized as the first cell.

In one embodiment, the first cell is a cell with a smallest cell index in the K cells.

In one embodiment, the first cell is a cell with a largest cell index in the K cells.

In one embodiment, when all other parameters are the same, a cell with a smaller cell index among the K cells is prioritized as the first cell.

In one embodiment, when all other parameters are the same, a cell with a larger cell index among the K cells is prioritized as the first cell.

In one embodiment, the other parameters comprise parameters other than affecting a determination of the first cell and cell index.

In one embodiment, the other parameters comprise priority.

In one embodiment, the other parameters comprise MCS.

In one embodiment, the other parameters comprise whether a PUCCH is configured.

In one embodiment, the K cells have the same other parameters.

In one embodiment, the first index set comprise K4 cell indices, and the K4 cell indices are respectively assigned to K4 cells, K4 being a positive integer greater than K; at least one cell in the K4 cells does not belong to the K cells; the K cells consist of all cells having the same other parameters in the K4 cells.

In one embodiment, the first DCI is used to schedule a PUDCH on each cell in the K4 cells.

In one embodiment, which one of the K cells is configured with a PUCCH is used to determine the first cell.

In one embodiment, which one of the K cells is configured with a PUCCH is used to determine that the first CSI set is transmitted on the PUSCH of the first cell in the K cells.

In one embodiment, the meaning of the phrase that the second field of the first DCI is used to determine the first cell includes: the second field in the first DCI indicates the first index set, the first index set comprises the K cell indices, and which one of the K cells is configured with a PUCCH is used to determine the first cell.

In one embodiment, among the K cells, a cell configured with a PUCCH is prioritized as the first cell.

In one embodiment, the first cell is a cell configured with a PUCCH in the K cells.

In one embodiment, the first cell is only one cell configured with a PUCCH in the K cells.

In one embodiment, when all other parameters are the same, a cell configured with a PUCCH in the K cells is prioritized as the first cell.

In one embodiment, when there exist K3 cells being configured with PUCCHs in the K cells and K3 is a positive integer greater than 1, other parameters are used to determine the first cell.

In one embodiment, the other parameters comprise parameters other than affecting a determination of the first cell and whether a PUCCH is configured.

In one embodiment, the other parameters comprise at least one of priority, MCS or cell index.

In one embodiment, the K cell indices are arranged in order in the first index set, and a cell index located at a given location in the first index set among the K cell indices is a cell index of the first cell.

In one embodiment, the meaning of the phrase that the second field of the first DCI is used to determine the first cell includes: the second field in the first DCI indicates the first index set, and the first index set comprises the K cell indices; the K cell indices are arranged in order in the first index set, and a cell index located at a given location in the first index set among the K cell indices is a cell index of the first cell.

In one embodiment, the given location is a location of a cell index ranked first in the first index set in the K cell indices.

In one embodiment, the given location is a location of a cell index ranked second in the first index set in the K cell indices.

In one embodiment, the given location is a location of a cell index ranked last in the first index set in the K cell indices.

In one embodiment, the given location is a location of a cell index ranked second to last in the first index set in the K cell indices.

In one embodiment, the given location is a location of a cell index comprising an MSB of the first index set in the K cell indices.

In one embodiment, the given location is a location of a cell index comprising an LSB of the first index set in the K cell indices.

In one embodiment, the given location is a location of a cell index closest to an MSB of the first index set among the K cell indices.

In one embodiment, the given location is a location of a cell index closest to an LSB of the first index set among the K cell indices.

In one embodiment, a candidate value of the second field comprises Q candidate values, Q being a positive integer greater than 1; the Q candidate values respectively indicate Q index sets; the first index set is an index set indicated by a value of the second field in the first DCI among the Q index sets; the Q candidate values are Q non-negative integers that are not equal to each other.

In one embodiment, a number of all candidate values in the second field is equal to Q.

In one embodiment, all candidate values of the second field are the Q candidate values.

In one embodiment, a number of all candidate values in the second field is greater than Q.

In one embodiment, at least one candidate value in all candidate values in the second field does not belong to the Q candidate values.

In one embodiment, a number of all candidate values in the second field is equal to the Q+1.

In one embodiment, a corresponding relation between the Q candidate values and the Q index sets is configured by an RRC signaling.

In one embodiment, the Q candidate values are Q code-points of the second field respectively.

In one embodiment, each one of the Q index sets comprises at least one cell index.

In one embodiment, each one of the Q index sets consists of at least one cell index.

In one embodiment, the second field comprises all or partial information in a DCI field Carrier Indicator.

In one embodiment, the second field comprises a DCI field Carrier Indicator.

In one embodiment, the second field is a DCI field Carrier Indicator.

### Embodiment 14

Embodiment 14 illustrates a structure block diagram of a processor in a first node according to one embodiment of the present application, as shown in FIG. 14. In FIG. 14, a processor 1400 in a first node comprises a first receiver 1401 and a first transmitter 1402.

In embodiment 14, the first receiver 1401 receives a first message set and a first DCI and executes a measurement on the first RS resource group; the first transmitter 1402 transmits a first CSI set on a PUSCH of a first cell.

In embodiment 14, the first message set comprises a first message, and the first DCI comprises a first field and a second field; the first CSI set comprises a first CSI; the first DCI is used to schedule PUSCHs on at least K cells, K being a positive integer greater than 1; the first cell is one of the K cells; the first field of the first DCI is used to trigger the first CSI; the second field of the first DCI is used to determine the first cell; the measurement performed on the first RS resource group is used to calculate the first CSI, and the first message is used to indicate the first RS resource group.

In one embodiment, the first DCI comprises K sub-fields, and the K sub-fields are respectively used for scheduling for the K cells; the second field of the first DCI comprises at least one of the K sub-fields.

In one embodiment, the K sub-fields respectively indicate K MCSs, the K MCSs are respectively used for K PUSCHs, and the K PUSCHs are respectively located on the K cells.

In one embodiment, the K sub-fields are respectively used to determine K cell indices, and the K cell indices are respectively assigned to the K cells.

In one embodiment, the first cell is a cell indicated by a sub-field located at a target location among the K sub-fields; the target location is the default.

In one embodiment, the K sub-fields are respectively used to determine priorities of K PUSCHs, and the K PUSCHs are respectively on the K cells.

In one embodiment, the second field in the first DCI indicates a first index set, the first index set comprises K cell indices, and the K cell indices are respectively assigned to the K cells.

In one embodiment, the first node is a UE.

In one embodiment, the first node is a relay node.

In one embodiment, the first transmitter 1402 transmits a signal other than the first CSI set on the PUSCH of the first cell.

In one embodiment, the first transmitter 1402 respectively transmits PUSCH(s) on (K−1) cell(s); the (K−1) cell(s) consists (consist) of all cells other than the first cell in the K cells.

In one embodiment, the first message is carried by an RRC IE; the measurement executed on the first RS resource group comprises a channel measurement, where all RS resources in the first RS resource group are on a same cell; the first DCI schedules K PUSCHs, and the K PUSCHs are located on the K cells respectively; the first CSI set is transmitted on only a PUSCH on the first cell of the K PUSCHs; the meaning of the phrase that the second field of the first DCI is used to determine the first cell includes: the second filed of the first DCI is used to determine that first CSI set is transmitted on the PUSCH of the first cell in the K cells.

In one embodiment, the K cells belong to a same PUCCH group.

In one embodiment, K BWPs are BWPs scheduled by the first DCI for the K cells, and the K cells have a same subcarrier spacing configuration.

In one embodiment, the first receiver 1401 comprises at least one of the antenna 452, the receiver 454, the receiving processor 456, the multi-antenna receiving processor 458, the controller/processor 459, the memory 460, or the data source 467 in Embodiment 4.

In one embodiment, the first transmitter 1402 comprises at least one of the antenna 452, the transmitter 454, the transmitting processor 468, the multi-antenna transmitting processor 457, the controller/processor 459, the memory 460, or the data source 467 in Embodiment 4.

### Embodiment 15

Embodiment 15 illustrates a structure block diagram of a processor in a second node according to one embodiment of the present application, as shown in FIG. 15. In FIG. 15, a processor 1500 of a second node comprises a second transmitter 1501 and a second receiver 1502.

In embodiment 15, the second transmitter 1501 transmits a first message set and a first DCI; the second receiver 1502 receives a first CSI set on a PUSCH of a first cell.

In embodiment 15, the first message set comprises a first message, and the first DCI comprises a first field and a second field; the first CSI set comprises a first CSI; the first DCI is used to schedule PUSCHs on at least K cells, K being a positive integer greater than 1; the first cell is one of the K cells; the first field of the first DCI is used to trigger the first CSI; the second field of the first DCI is used to determine the first cell; a measurement performed on a first RS resource group is used to calculate the first CSI, and the first message is used to indicate the first RS resource group.

In one embodiment, the first DCI comprises K sub-fields, and the K sub-fields are respectively used for scheduling for the K cells; the second field of the first DCI comprises at least one of the K sub-fields.

In one embodiment, the K sub-fields respectively indicate K MCSs, the K MCSs are respectively used for K PUSCHs, and the K PUSCHs are respectively located on the K cells.

In one embodiment, the K sub-fields are respectively used to determine K cell indices, and the K cell indices are respectively assigned to the K cells.

In one embodiment, the first cell is a cell indicated by a sub-field located at a target location among the K sub-fields; the target location is the default.

In one embodiment, the K sub-fields are respectively used to determine priorities of K PUSCHs, and the K PUSCHs are respectively on the K cells.

In one embodiment, the second field in the first DCI indicates a first index set, the first index set comprises K cell indices, and the K cell indices are respectively assigned to the K cells.

In one embodiment, the second node is a base station.

In one embodiment, the second node is a UE.

In one embodiment, the second node is a relay node.

In one embodiment, the second transmitter 1501 transmits an RS on the first RS resource group.

In one embodiment, the second receiver 1502 receives a signal other than the first CSI set on the PUSCH of the first cell.

In one embodiment, the second receiver 1502 receives PUSCH(s) on (K−1) cell(s) respectively; the (K−1) cell(s) consists (consist) of all cells other than the first cell in the K cells.

In one embodiment, the first message is carried by an RRC IE; the measurement executed on the first RS resource group comprises a channel measurement, where all RS resources in the first RS resource group are on a same cell; the first DCI schedules K PUSCHs, and the K PUSCHs are located on the K cells respectively; the first CSI set is transmitted on only a PUSCH on the first cell of the K PUSCHs; the meaning of the phrase that the second field of the first DCI is used to determine the first cell includes: the second filed of the first DCI is used to determine that first CSI set is transmitted on the PUSCH of the first cell in the K cells.

In one embodiment, the K cells belong to a same PUCCH group.

In one embodiment, K BWPs are BWPs scheduled by the first DCI for the K cells, and the K cells have a same subcarrier spacing configuration.

In one embodiment, the second transmitter 1501 comprises at least one of the antenna 420, the transmitter 418, the transmitting processor 416, the multi-antenna transmitting processor 471, the controller/processor 475, or the memory 476 in Embodiment 4.

In one embodiment, the second receiver 1502 comprises at least one of the antenna 420, the receiver 418, the receiving processor 470, the multi-antenna receiving processor 472, the controller/processor 475, the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro-cellular base stations, micro-cellular base stations, Pico base stations, home base stations, relay base stations, eNB, gNB, Transmitter Receiver Points (TRPs), GNSS, relay satellites, satellite base stations, space base stations, RSUs, UAVs, test devices, such as a transceiver or a signaling tester that simulates some functions of a base station, and other wireless communication devices.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first message set and a first DCI, the first message set comprising a first message, the first DCI comprising a first field and a second field; performing a measurement on a first RS resource group; and
a first transmitter, transmitting a first CSI set on a PUSCH of a first cell, the first CSI set comprising a first CSI;
wherein the first DCI is used to schedule PUSCHs on at least K cells, K being a positive integer greater than 1; the first cell is one of the K cells; the first field of the first DCI is used to trigger the first CSI; the second field of the first DCI is used to determine the first cell; the measurement performed on the first RS resource group is used to calculate the first CSI, and the first message is used to indicate the first RS resource group.

2. The first node according to claim 1, wherein the first cell is a cell corresponding to a smallest cell index among the K cells.

3. The first node according to claim 1, wherein the first DCI comprises K sub-fields, and the K sub-fields are respectively used for scheduling for the K cells; the second field of the first DCI comprises at least one of the K sub-fields.

4. The first node according to claim 3, wherein the K sub-fields are respectively used to determine K cell indices, and the K cell indices are respectively assigned to the K cells.

5. The first node according to claim 1, wherein the K cells belong to a same PUCCH group.

6. The first node according to claim 1, wherein the second field in the first DCI indicates a first index set, the first index set comprises K cell indices, and the K cell indices are respectively assigned to the K cells.

7. A second node for wireless communications, comprising:
a second transmitter, transmitting a first message set and a first DCI, the first message set comprising a first message, the first DCI comprising a first field and a second field; and
a second receiver, receiving a first CSI set on a PUSCH of a first cell, the first CSI set comprising a first CSI;
wherein the first DCI is used to schedule PUSCHs on at least K cells, K being a positive integer greater than 1; the first cell is one of the K cells; the first field of the first DCI is used to trigger the first CSI; the second field of the first DCI is used to determine the first cell; a measurement performed on a first RS resource group is used to calculate the first CSI, and the first message is used to indicate the first RS resource group.

8. The second node according to claim 7, wherein the first cell is a cell corresponding to a smallest cell index among the K cells.

9. The second node according to claim 7, wherein the first DCI comprises K sub-fields, and the K sub-fields are respectively used for scheduling for the K cells; the second field of the first DCI comprises at least one of the K sub-fields;
or, the second field in the first DCI indicates a first index set, the first index set comprises K cell indices, and the K cell indices are respectively assigned to the K cells.

10. The second node according to claim 9, wherein the K sub-fields are respectively used to determine K cell indices, and the K cell indices are respectively assigned to the K cells.

11. A method in a first node for wireless communications, comprising:
receiving a first message set and a first DCI, the first message set comprising a first message, the first DCI comprising a first field and a second field;
performing a measurement on a first RS resource group; and
transmitting a first CSI set on a PUSCH of a first cell, the first CSI set comprising a first CSI;
wherein the first DCI is used to schedule PUSCHs on at least K cells, K being a positive integer greater than 1; the first cell is one of the K cells; the first field of the first DCI is used to trigger the first CSI; the second field of the first DCI is used to determine the first cell; the measurement performed on the first RS resource group is used to calculate the first CSI, and the first message is used to indicate the first RS resource group.

12. The method according to claim 11, wherein the first cell is a cell corresponding to a smallest cell index among the K cells.

13. The method according to claim 11, wherein the first DCI comprises K sub-fields, and the K sub-fields are respectively used for scheduling for the K cells; the second field of the first DCI comprises at least one of the K sub-fields.

14. The method according to claim 13, wherein the K sub-fields are respectively used to determine K cell indices, and the K cell indices are respectively assigned to the K cells.

15. The method according to claim 11, wherein the K cells belong to a same PUCCH group.

16. The method according to claim 11, wherein the second field in the first DCI indicates a first index set, the first index set comprises K cell indices, and the K cell indices are respectively assigned to the K cells.

17. A method in a second node for wireless communications, comprising:
transmitting a first message set and a first DCI, the first message set comprising a first message, the first DCI comprising a first field and a second field; and
receiving a first CSI set on a PUSCH of a first cell, the first CSI set comprising a first CSI;
wherein the first DCI is used to schedule PUSCHs on at least K cells, K being a positive integer greater than 1; the first cell is one of the K cells; the first field of the first DCI is used to trigger the first CSI; the second field of the first DCI is used to determine the first cell; a measurement performed on a first RS resource group is used to calculate the first CSI, and the first message is used to indicate the first RS resource group.

18. The method according to claim 17, wherein the first cell is a cell corresponding to a smallest cell index among the K cells.

19. The method according to claim 17, wherein the first DCI comprises K sub-fields, and the K sub-fields are respectively used for scheduling for the K cells; the second field of the first DCI comprises at least one of the K sub-fields;
or, the second field in the first DCI indicates a first index set, the first index set comprises K cell indices, and the K cell indices are respectively assigned to the K cells.

20. The method according to claim 19, wherein the K sub-fields are respectively used to determine K cell indices, and the K cell indices are respectively assigned to the K cells.
